(19) United States
(12) Patent Application Publication
(10) Pub. No.: US 2024/0040568 A1
(43) Pub. Date: Feb. 1, 2024

(54) RESOURCE PATTERN CONFIGURATION WITHIN A SLOT FOR SIDELINK COMMUNICATION

(71) Applicant: Qualcomm Incorporated, San Diego, CA (US)

(72) Inventors: Ahmed Elshafie, San Diego, CA (US); Wei Yang, San Diego, CA (US); Seyedkianoush Hosseini, San Diego, CA (US)

(21) Appl. No.: 17/876,439

(22) Filed: Jul. 28, 2022

(51) Int. Cl. H04W 72/04

(52) U.S. Cl. CPC H04W 72/0406; H04W 72/0446

(57) ABSTRACT

Methods, systems, and devices for wireless communications are described. Generally, the described techniques provide for a configuration of multiple resource patterns for one or more user equipments (UEs) to use for transmission of sidelink signals over a quantity of transmission time intervals (TTIs) (e.g., sub-slots) within a slot. For example, a UE may determine a resource pattern to use for transmitting sidelink signals based on an assignment from a network entity, an initial frequency offset, information included in control signaling, or any combination thereof. In some examples, the UE may transmit, via the sidelink channel, an indication of the resource pattern used by the UE, such that other UEs in the system may determine the resource pattern used by the UE. The UE may transmit a sidelink signal in accordance with the resource pattern, while other UEs may use other resource patterns for sidelink transmissions within the same slot.

### FIELD OF TECHNOLOGY

The following relates to wireless communications, including resource pattern configuration within a slot for sidelink communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, UEs may communicate directly with one another in a sidelink communications mode. A UE may reserve sidelink resources for communications by indicating, to one or more other UEs, frequency resources (e.g., a number of subchannels) reserved by the UE for one or more slots. However, in some cases, slot-based sidelink reservations may fail to support efficient resource usage, for example, if multiple different UEs are contending for the sidelink resources. Additionally, or alternatively, using slot-based sidelink reservations may cause UEs to fail to satisfy latency thresholds for communications (e.g., based on relatively few slot-based reservation opportunities).

### SUMMARY

The described techniques relate to improved methods, systems, devices, and apparatuses that support resource pattern configuration within a slot for sidelink communication. For example, the described techniques provide for improved sidelink resource usage and reduced sidelink communication latency. In some wireless communications systems, a network entity may configure multiple resource patterns for sidelink communications within a slot. For example, the resource patterns may correspond to a resource pool, and a resource pattern may indicate a set of resources spanning one or more subchannels and one or more transmission time intervals (TTIs) (e.g., sub-slots or mini-slots) within a slot. For example, a UE may determine a resource pattern to use for transmitting sidelink signals based on an assignment from a network entity, an initial frequency offset, information included in control signaling, or any combination thereof. In some examples, the UE may transmit, via the sidelink channel, an indication of the resource pattern used by the UE, such that other UEs in the system may determine the resource pattern used by the UE. The UE may transmit a sidelink signal in accordance with the resource pattern, and—in some cases—one or more other UEs may use other resource patterns for sidelink transmission within the same slot.

A method for wireless communications at a user equipment (UE) is described. The method may include receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot and transmitting a sidelink signal via the set of resources corresponding to the resource pattern of the set of multiple resource patterns based on the control signal.

An apparatus for wireless communications at a UE is described. The apparatus may include a processor, memory coupled with the processor, and instructions stored in the memory. The instructions may be executable by the processor to cause the apparatus to receive a control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot and transmit a sidelink signal via the set of resources corresponding to the resource pattern of the set of multiple resource patterns based on the control signal.

Another apparatus for wireless communications at a UE is described. The apparatus may include means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot and means for transmitting a sidelink signal via the set of resources corresponding to the resource pattern of the set of multiple resource patterns based on the control signal.

A non-transitory computer-readable medium storing code for wireless communications at a UE is described. The code may include instructions executable by a processor to receive a control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot and transmit a sidelink signal via the set of resources corresponding to the resource pattern of the set of multiple resource patterns based on the control signal.

Some examples of the method, apparatuses, and non-transitory computer-readable medium described herein may further include operations, features, means, or instructions for receiving a second control signal assigning the resource pattern of the set of multiple resource patterns to the UE, where the sidelink signal may be transmitted via the set of resources corresponding to the resource pattern based on the second control signal.

Some examples of the method, apparatuses, and non-transitory computer-readable medium described herein may further include operations, features, means, or instructions for determining the resource pattern from the set of multiple resource patterns based on a source identifier (ID) for the sidelink signal, a destination ID for the sidelink signal, or both, where the sidelink signal may be transmitted via the set of resources corresponding to the resource pattern based on the determining.

Some examples of the method, apparatuses, and non-transitory computer-readable medium described herein may further include operations, features, means, or instructions for transmitting a sidelink control signal indicating the resource pattern based on transmitting the sidelink signal via the set of resources corresponding to the resource pattern.

In some examples of the method, apparatuses, and non-transitory computer-readable medium described herein, the set of multiple resource patterns corresponds to a set of multiple transport block sizes, a set of multiple transmission priorities, or both, and the resource pattern of the set of multiple resource patterns corresponds to a transport block size for the sidelink signal, a transmission priority for the sidelink signal, or both.

In some examples of the method, apparatuses, and non-transitory computer-readable medium described herein, transmitting the sidelink signal may include operations, features, means, or instructions for performing frequency hopping for transmission of the sidelink signal from a first set of subcarriers during a first sub-slot of the slot to a second set of subcarriers different from the first set of subcarriers during a second sub-slot of the slot based on the resource pattern, where the different TTIs include the first sub-slot and the second sub-slot.

In some examples of the method, apparatuses, and non-transitory computer-readable medium described herein, the first set of subcarriers may be separated from the second set of subcarriers in frequency by a frequency offset.

In some examples of the method, apparatuses, and non-transitory computer-readable medium described herein, transmitting the sidelink signal may include operations, features, means, or instructions for transmitting a first portion of the sidelink signal during a first sub-slot of the slot via a first set of subcarriers associated with a first resource index based on one or more initial offset values and transmitting a second portion of the sidelink signal during a second sub-slot of the slot via a second set of subcarriers associated with a second resource index based on the first resource index, where the different TTIs include the first sub-slot and the second sub-slot.

Some examples of the method, apparatuses, and non-transitory computer-readable medium described herein may further include operations, features, means, or instructions for receiving a second control signal indicating a set of offset values, where the one or more initial offset values may be based on the set of offset values.

In some examples of the method, apparatuses, and non-transitory computer-readable medium described herein, an offset value of the set of offset values may be common across UEs for the resource pool or may be specific to the UE for the resource pool.

Some examples of the method, apparatuses, and non-transitory computer-readable medium described herein may further include operations, features, means, or instructions for transmitting a sidelink control signal including a bit map indicating the one or more initial offset values based on transmitting the first portion of the sidelink signal via the first set of subcarriers associated with the first resource index based on the one or more initial offset values.

In some examples of the method, apparatuses, and non-transitory computer-readable medium described herein, the second resource index may be based on the first resource index and a staircase technique for resource assignment or a bit reversal permutation technique for resource assignment.

In some examples of the method, apparatuses, and non-transitory computer-readable medium described herein, the resource pattern indicates, for the UE, a first set of subcarriers and a second set of subcarriers non-contiguous in frequency within a sub-slot, and the transmitting the sidelink signal may include operations, features, means, or instructions for refraining from transmitting a portion of the sidelink signal via the second set of subcarriers based on the second set of subcarriers being non-contiguous in frequency with the first set of subcarriers, repeating a transport block transmission via the second set of subcarriers based on the second set of subcarriers being non-contiguous in frequency with the first set of subcarriers, or transmitting a first transport block via the first set of subcarriers and transmitting a second transport block via the second set of subcarriers based on the second set of subcarriers being non-contiguous in frequency with the first set of subcarriers, where the different TTIs include the sub-slot.

Some examples of the method, apparatuses, and non-transitory computer-readable medium described herein may further include operations, features, means, or instructions for receiving, in response to the sidelink signal, a sidelink feedback signal via sidelink feedback channel resources, where the sidelink feedback channel resources may be based on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof, where the different TTIs include the first sub-slot and the last sub-slot.

A method for wireless communications at a network entity is described. The method may include transmitting a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot, transmitting a second control signal assigning a first resource pattern of the set of multiple resource patterns to a first UE for sidelink communication within the slot, and transmitting a third control signal assigning a second resource pattern of the set of multiple resource patterns to a second UE for sidelink communication within the slot.

An apparatus for wireless communications at a network entity is described. The apparatus may include a processor, memory coupled with the processor, and instructions stored in the memory. The instructions may be executable by the processor to cause the apparatus to transmit a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot, transmit a second control signal assigning a first resource pattern of the set of multiple resource patterns to a first UE for sidelink communication within the slot, and transmit a third control signal assigning a second resource pattern of the set of multiple resource patterns to a second UE for sidelink communication within the slot.

Another apparatus for wireless communications at a network entity is described. The apparatus may include means for transmitting a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot, means for transmitting a second control signal assigning a first resource pattern of the set of multiple resource patterns to a first UE for sidelink communication within the slot, and means for transmitting a third control signal assigning a second resource pattern of the set of multiple resource patterns to a second UE for sidelink communication within the slot.

A non-transitory computer-readable medium storing code for wireless communications at a network entity is described. The code may include instructions executable by a processor to transmit a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot, transmit a second control signal assigning a first resource pattern of the set of multiple resource patterns to a first UE for sidelink communication within the slot, and transmit a third control signal assigning a second resource pattern of the set of multiple resource patterns to a second UE for sidelink communication within the slot.

Some examples of the method, apparatuses, and non-transitory computer-readable medium described herein may further include operations, features, means, or instructions for transmitting a fourth control signal indicating a set of offset values for the first UE and the second UE, where an offset value of the set of offset values indicates an assigned set of resources for sidelink communication based on an assigned resource pattern.

In some examples of the method, apparatuses, and non-transitory computer-readable medium described herein, the set of offset values includes a first offset value specific to the first UE for the resource pool, a second offset value specific to the second UE for the resource pool, a third offset value common to the first UE and the second UE for the resource pool, or any combination thereof.

In some examples of the method, apparatuses, and non-transitory computer-readable medium described herein, the first resource pattern indicates, for the first UE, a first set of subcarriers and a second set of subcarriers non-contiguous in frequency within a sub-slot of the slot, and the method, apparatuses, and non-transitory computer-readable medium may include further operations, features, means, or instructions for transmitting a fourth control signal assigning the second set of subcarriers to the first UE, the second UE, or a third UE for sidelink communication based on the second set of subcarriers being non-contiguous with the first set of subcarriers within the sub-slot, where the different TTIs include the sub-slot.

In some examples of the method, apparatuses, and non-transitory computer-readable medium described herein, the set of multiple resource patterns corresponds to a set of multiple transport block sizes, a set of multiple transmission priorities, or both, the first resource pattern of the set of multiple resource patterns corresponds to a first transport block size for a first sidelink signal corresponding to the first UE, a first transmission priority for the first sidelink signal corresponding to the first UE, or both, and the second resource pattern of the set of multiple resource patterns corresponds to a second transport block size for a second sidelink signal corresponding to the second UE, a second transmission priority for the second sidelink signal corresponding to the second UE, or both.

A method for wireless communications at a UE is described. The method may include receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot, detecting a sidelink signal via the set of resources corresponding to the resource pattern of the set of multiple resource patterns based on the control signal, and communicating based on the resource pattern for the detected sidelink signal.

An apparatus for wireless communications at a UE is described. The apparatus may include a processor, memory coupled with the processor, and instructions stored in the memory. The instructions may be executable by the processor to cause the apparatus to receive a control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot, detect a sidelink signal via the set of resources corresponding to the resource pattern of the set of multiple resource patterns based on the control signal, and communicate based on the resource pattern for the detected sidelink signal.

Another apparatus for wireless communications at a UE is described. The apparatus may include means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot, means for detecting a sidelink signal via the set of resources corresponding to the resource pattern of the set of multiple resource patterns based on the control signal, and means for communicating based on the resource pattern for the detected sidelink signal.

A non-transitory computer-readable medium storing code for wireless communications at a UE is described. The code may include instructions executable by a processor to receive a control signal that indicates a set of multiple resource patterns corresponding to a resource pool, a resource pattern of the set of multiple resource patterns indicative of a set of resources including one or more time resources and one or more frequency resources allocated for sidelink communication by one UE across different TTIs within a slot, detect a sidelink signal via the set of resources corresponding to the resource pattern of the set of multiple resource patterns based on the control signal, and communicate based on the resource pattern for the detected sidelink signal.

In some examples of the method, apparatuses, and non-transitory computer-readable medium described herein, the communicating may include operations, features, means, or instructions for receiving the sidelink signal based on the resource pattern.

Some examples of the method, apparatuses, and non-transitory computer-readable medium described herein may further include operations, features, means, or instructions for transmitting, in response to the sidelink signal, a sidelink feedback signal via sidelink feedback channel resources, where the sidelink feedback channel resources may be based on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof, where the different TTIs include the first sub-slot and the last sub-slot.

In some examples of the method, apparatuses, and non-transitory computer-readable medium described herein, the communicating may include operations, features, means, or instructions for transmitting a second sidelink signal via a second set of resources corresponding to a second resource pattern of the set of multiple resource patterns based on the resource pattern for the detected sidelink signal.

In some examples of the method, apparatuses, and non-transitory computer-readable medium described herein, detecting the sidelink signal may include operations, features, means, or instructions for receiving a sidelink control signal associated with the sidelink signal and indicating the resource pattern for the sidelink signal.

Some examples of the method, apparatuses, and non-transitory computer-readable medium described herein may further include operations, features, means, or instructions for determining the resource pattern for the sidelink signal based on a source ID for the sidelink signal, a destination ID for the sidelink signal, or both.

In some examples of the method, apparatuses, and non-transitory computer-readable medium described herein, detecting the sidelink signal may include operations, features, means, or instructions for receiving a sidelink control signal associated with the sidelink signal and including a bit map indicating one or more initial offset values for the sidelink signal and determining the set of resources corresponding to the resource pattern for the sidelink signal based on the bit map.

### BRIEF DESCRIPTION OF THE DRAWINGS

FIG. 1 illustrates an example of a wireless communications system that supports resource pattern configuration within a slot for sidelink communication in accordance with one or more aspects of the present disclosure.

FIG. 2 illustrates an example of a network architecture that supports resource pattern configuration within a slot for sidelink communication in accordance with one or more aspects of the present disclosure.

FIG. 3 illustrates an example of a wireless communications system that supports resource pattern configuration within a slot for sidelink communication in accordance with one or more aspects of the present disclosure.

FIG. 4 illustrates an example of a resource pattern configuration that supports resource pattern configuration within a slot for sidelink communication in accordance with one or more aspects of the present disclosure.

FIGS. 5A and 5B illustrate examples of frequency allocations that support resource pattern configuration within a slot for sidelink communication in accordance with one or more aspects of the present disclosure.

FIGS. 6, 7A, and 7B illustrate examples of resource pattern configurations that support resource pattern configuration within a slot for sidelink communication in accordance with one or more aspects of the present disclosure.

FIG. 8 illustrates an example of a process flow that supports resource pattern configuration within a slot for sidelink communication in accordance with one or more aspects of the present disclosure.

FIGS. 9 and 10 show block diagrams of devices that support resource pattern configuration within a slot for sidelink communication in accordance with one or more aspects of the present disclosure.

FIG. 11 shows a block diagram of a communications manager that supports resource pattern configuration within a slot for sidelink communication in accordance with one or more aspects of the present disclosure.

FIG. 12 shows a diagram of a system including a device that supports resource pattern configuration within a slot for sidelink communication in accordance with one or more aspects of the present disclosure.

FIGS. 13 and 14 show block diagrams of devices that support resource pattern configuration within a slot for sidelink communication in accordance with one or more aspects of the present disclosure.

FIG. 15 shows a block diagram of a communications manager that supports resource pattern configuration within a slot for sidelink communication in accordance with one or more aspects of the present disclosure.

FIG. 16 shows a diagram of a system including a device that supports resource pattern configuration within a slot for sidelink communication in accordance with one or more aspects of the present disclosure.

FIGS. 17 through 19 show flowcharts illustrating methods that support resource pattern configuration within a slot for sidelink communication in accordance with one or more aspects of the present disclosure.

### DETAILED DESCRIPTION

In some wireless communications systems, multiple user equipment (UEs) may communicate directly with one another in a sidelink communications mode. A UE may reserve sidelink resources for communications by indicating, to one or more other UEs, frequency resources (e.g., one or more subchannels) reserved by the UE during a current slot (e.g., a time domain resource) and frequency resources reserved by the UE during upcoming slots (e.g., up to two upcoming slots). In some cases, to support improved granularity of sidelink channel reservations, UEs may reserve resources at one or more fractional portions of a slot. Such fractional portions may be referred to as transmission time intervals (TTIs), sub-slots, or mini-slots within the slot. For example, a UE may reserve one or more sub-slots (e.g., spanning four symbols of a slot or some other quantity of time) and a quantity of frequency resources (e.g., subchannels, subcarriers) for a respective sub-slot of the one or more sub-slots for sidelink transmission. In some examples, parameters of the frequency reservations (e.g., a quantity of subcarriers, a location in the frequency domain, or both reserved by the UE) associated with respective sub-slots may be different to support flexible frequency allocation and sharing. However, communicating reservation signaling (e.g., sidelink control information (SCI) signaling) indicating a sidelink channel reservation for one or more sub-slots and one or more frequency resources for respective sub-slots may experience significant overhead due to increased slot granularity.

To improve reservation signaling for sub-slot-based sidelink communications, a wireless communications system may configure multiple resource patterns for a resource pool. In some cases, a network entity may indicate, to a set of UEs (e.g., via a control message), one or more resource patterns associated with a resource pool allocated for sidelink communications between the set of UEs. In some cases, one or more UEs may identify a resource pattern of the multiple resource patterns to use for sidelink communications, where the resource pattern indicates time resources, frequency resources, or both at which to perform the sidelink communications (e.g., a set a sub-slots within a slot, corresponding subcarriers allocated for each sub-slot of the set of sub-slots, or both). For example, a UE may receive (e.g., from a network entity) an indication assigning a resource pattern of the multiple resource patterns to the UE, and the UE may determine to perform one or more subsequent sidelink transmissions in accordance with the assigned resource pattern. Alternatively, a UE may determine the resource pattern to use based on information associated with an upcoming transmission of a sidelink signal (e.g., a source identifier (ID), a destination ID, or both). The UE may transmit a sidelink signal according to the resource pattern (e.g., the assigned resource pattern, the determined resource pattern).

In some cases, the UE may indicate the resource pattern to other UEs (e.g., via SCI). Additionally, or alternatively, one or more other UEs (e.g., UEs monitoring a sidelink channel) may detect the sidelink signal transmitted by the UE and may use information in the sidelink signal to determine the resource pattern. The one or more other UEs may receive the sidelink signal based on determining the resource pattern used for the sidelink signal. Additionally, or alternatively, the one or more other UEs may determine other resource patterns to use for sidelink signaling based on determining the resource pattern used for the sidelink signal. Such techniques for sidelink resource reservations may support flexibility and sub-slot granularity in sidelink resource reservations while improving signaling overhead associated with the sidelink resource reservations.

Aspects of the disclosure are initially described in the context of wireless communications systems. Aspects of the disclosure are further illustrated by and described with reference to resource diagrams and process flows. Aspects of the disclosure are further illustrated by and described with reference to apparatus diagrams, system diagrams, and flowcharts that relate to resource pattern configuration within a slot for sidelink communication.

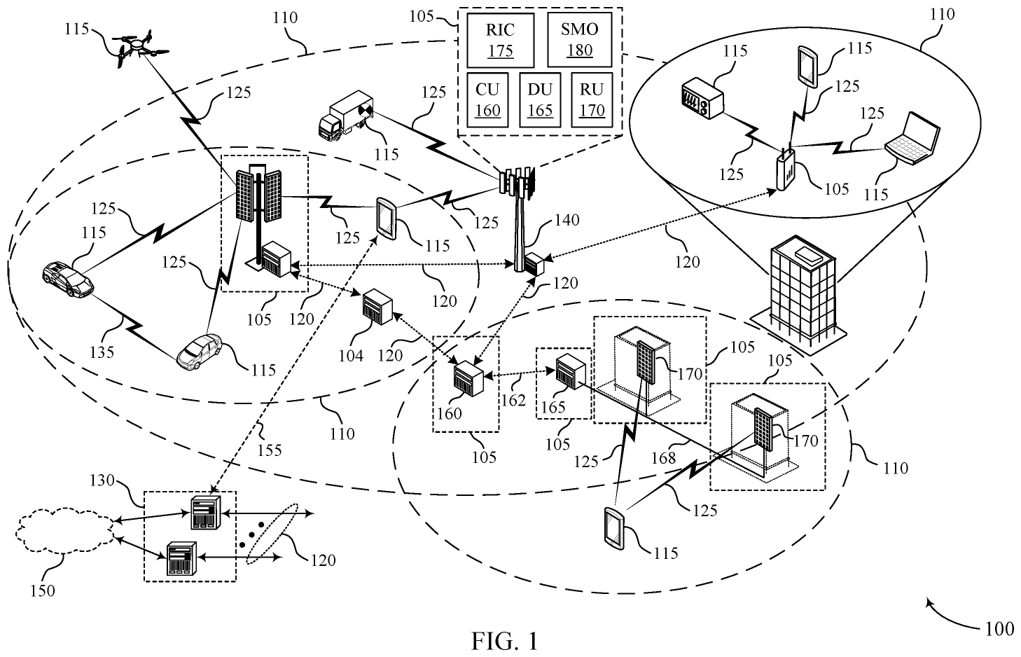

FIG. 1 illustrates an example of a wireless communications system 100 that supports resource pattern configuration within a slot for sidelink communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource pattern configuration within a slot for sidelink communication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support sidelink resource scheduling between multiple UEs 115. In some cases, a set of UEs 115 operating via a sidelink channel may reserve resources (e.g., time and frequency resources) over one or more fractional portions of a slot (e.g., a TTI, a sub-slot, a mini-slot). For example, a first UE 115 may indicate (e.g., via SCI), to one or more second UEs 115, a quantity of frequency resources (e.g., subcarriers) and time resources (e.g., sub-slots) reserved for communications by the first UE 115 (e.g., to prevent the one or more second UEs 115 from reserving or transmitting in the indicated resources). As time domain granularity increases for sidelink signaling (e.g., from slot-based sidelink reservations to sub-slot-based sidelink reservations), however, UEs 115 performing reservation signaling may experience significant overhead (e.g., due to an increased frequency of scheduling messaging, an increased complexity of scheduling messaging, or both).

In some cases, the wireless communications system 100 may configure one or more resource patterns, which may reduce signaling overhead related to resource reservation. For example, a network entity 105 may configure a set of resource patterns per resource pool and may transmit an indication (e.g., via downlink control information (DCI) signaling, radio resource control (RRC) signaling, MAC control element (MAC-CE) signaling) of the set of resource patterns to one or more UEs 115 utilizing the corresponding resource pool. A UE 115 may determine to use a resource pattern from the set of configured resource patterns based on a network assignment, signal parameters (e.g., a source ID, a destination ID, or both), an initial offset value corresponding to a resource pattern (e.g., a staircase pattern, a bit-reversal permutation pattern), or any combination thereof. The UE 115 may transmit a sidelink signal to another UE 115 in the wireless communications system 100 in one or more resources indicated by the resource pattern.

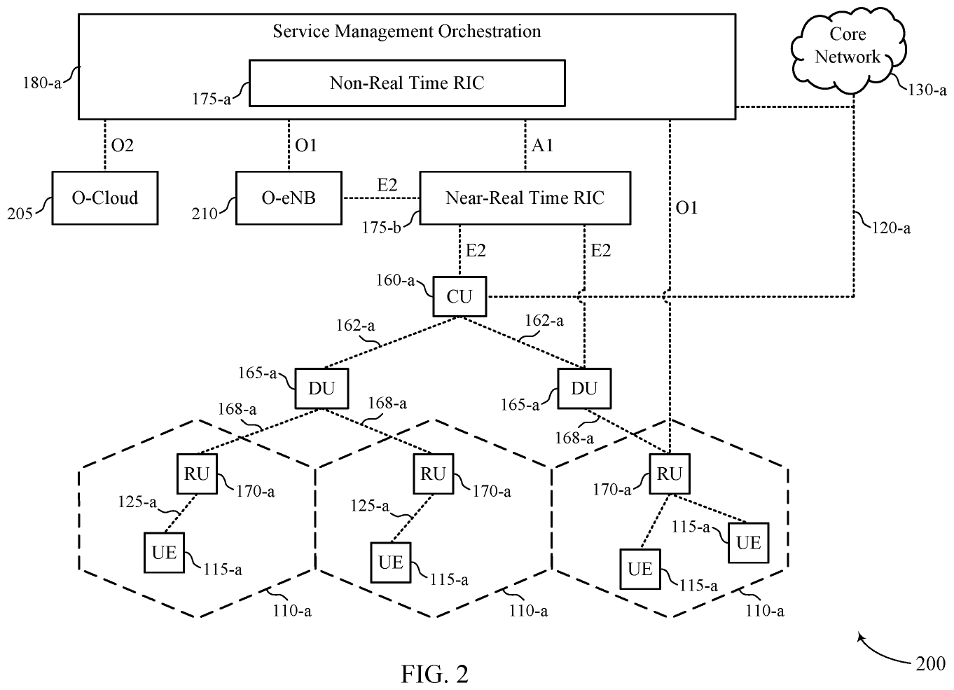

FIG. 2 illustrates an example of a network architecture 200 that supports resource pattern configuration within a slot for sidelink communication in accordance with one or more aspects of the present disclosure. In some examples, the network architecture 200 may be an example of a disaggregated base station architecture, a disaggregated RAN architecture, or a combination thereof. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

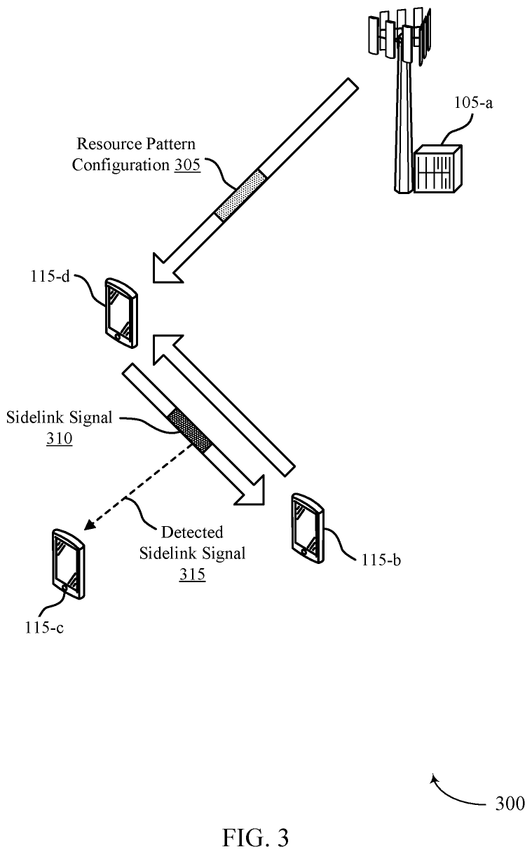

FIG. 3 illustrates an example of a wireless communications system 300 that supports resource pattern configuration within a slot for sidelink communication in accordance with one or more aspects of the present disclosure. In some cases, the wireless communications system 300 may implement aspects of the wireless communications system 100, the network architecture 200, or both as described herein with reference to FIGS. 1 and 2. For example, the wireless communications system 300 may include a network entity 105-a and a set of UEs 115 (e.g., the UE 115-b, the UE 115-c, and the UE 115-d), which may be respective examples of a network entity 105 and UEs 115 as described with reference to FIGS. 1 and 2. In some examples, the network entity 105-a may be an example of a base station, an RU, a DU, a CU, or some other network entity or network device or a combination of network entities or network devices. The network entity 105-a may configure one or more of the UEs 115 with a set of resource patterns to use for sidelink communications. For example, the resource patterns may define resource allocations across TTIs (e.g., sub-slots) within a slot.

In some wireless communications applications, a UE 115 may communicate directly with another UE 115 in a sidelink communications configuration, for example, via a sidelink channel. The UE 115 may utilize one or more resources (e.g., time-frequency resources) to transmit sidelink signals to another UE 115. In some cases, the UE 115 may determine the one or more time-frequency resources prior to transmitting the sidelink signal (e.g., via reservation signaling). For example, a UE 115-d may transmit (e.g., to a UE 115-b) an SCI signal (e.g., via a sidelink control channel, via a sidelink shared channel) indicating a resource reservation for a current slot and one or more upcoming slots (e.g., up to a preconfigured threshold quantity of reservations or slots). The SCI reservation signal may indicate a respective transmission index, a quantity of subchannels being reserved (e.g., z subchannels reserved for each transmission), a respective starting subchannel, a respective slot for each transmission of the one or more transmissions (e.g., the current transmission and up to two upcoming transmissions), or any combination thereof. In some cases, the UE 115-d may periodically retransmit the reservation signal according to a signal period.

Additionally, or alternatively, the UE 115-d may determine a corresponding feedback resource for each transmission reservation in a resource pool. The feedback resource may support transmission of a feedback signal (e.g., a HARQ signal or other feedback message) in response to a sidelink signal. For example, the UE 115-d may identify a mapping between a physical sidelink shared channel (PSSCH) transmission (e.g., the sidelink signal) and a corresponding physical shared feedback channel (PSFCH) resource (e.g., for communicating feedback) based on frequency resources of the PSSCH (e.g., a starting subchannel, a quantity of subchannels, or both), an index of a slot of the PSSCH, parameters of the transmission (e.g., a source ID, a destination ID, or a function of the source ID and the destination ID), or any combination thereof. In some cases, the quantity of available PSFCH resources (e.g., physical resource blocks (PRBs)) may be associated with (e.g., equal to or greater than) a quantity of UEs 115 communicating via the resource pool.

In some examples, a UE 115-d may select and reserve fractional portions of a slot (e.g., a sub-slot, a mini-slot) for sidelink transmission. The UE 115-d may reserve one or more sub-slots (e.g., four-symbols of a slot, or some other TTI) within a slot. In some cases, the UE 115-d may transmit reservation signaling via SCI to indicate the reserved one or more sub-slots. In some examples, each sub-slot within a slot may be self-schedulable (e.g., by a UE 115) and decodable (e.g., including a PSCCH and a PSSCH). In some examples, a sub-slot may include a gap symbol or may be separated from another sub-slot by a gap symbol. Additionally, or alternatively, a PSCCH transmission (e.g., a stage-one SCI (SCI-1) message) may schedule a quantity of sub-slots (e.g., contiguous sub-slots) for PSSCH transmission (e.g., from a same UE 115). In some other systems, UEs 115 reserving time domain resources in a relatively higher granularity (e.g., sub-slots, as compared to slots) may transmit a relatively higher quantity of bits in SCI to support sub-slot reservation, thereby increasing signaling overhead.

In accordance with techniques disclosed herein, a network entity 105-a may configure a set of resource patterns per resource pool for performing sidelink communications over a quantity of sub-slots (e.g., multiple TTIs within a slot). For example, the network entity 105-a may indicate, via a control message (e.g., including a resource pattern configuration 305), multiple resource patterns for a corresponding resource pool to one or more UEs 115. The control message may be an example of an RRC message, a MAC-CE, a DCI message, or any combination thereof. The control message may define resource configurations (e.g., time and frequency resource configurations) for different resource patterns or may indicate resource pattern indices corresponding to specific resource patterns from a set of pre-configured resource patterns. In some examples, a first UE 115-d may receive the resource pattern configuration 305 and may relay—or otherwise forward—the resource pattern configuration 305 to one or more other UEs 115 of the wireless communications system 300.

A UE 115 (e.g., the UE 115-d) may determine a resource pattern (e.g., corresponding to a respective quantity and position of subchannels allocated for one or more sub-slots of a set of sub-slots contiguous in the time domain) of the multiple resource patterns to use for transmission of a sidelink signal 310, which may reduce overhead related to reservation signaling. For example, the UE 115 may indicate the reserved resource pattern, rather than indicate the specific time and frequency resources reserved by the UE 115, which may reduce the quantity of bits used to indicate the reserved resources.

In some examples, the UE 115-d may receive control signaling (e.g., SCI, DCI, or both) assigning a resource pattern of the multiple resource patterns for the UE 115-d to use for transmission of the sidelink signal 310. For example, the network entity 105-a may allocate sidelink resources for the UE 115-d (e.g., according to a sidelink mode 1 configuration or via configured grants) and may indicate a resource pattern for the UE 115-a to use for transmission of the sidelink signal 310 via DCI signaling (e.g., a DCI message with a format DCI 3_x). In some cases, the network entity 105-a may indicate (e.g., via DCI) a subset of the multiple resource patterns for the UE 115-d to select from, and the UE 115-d may select a resource pattern to use for the sidelink signal 310 from the subset. In some examples, a UE 115 reserving sidelink resources to transmit the sidelink signal 310 may indicate (e.g., to one or more other UEs 115) the resource pattern corresponding to a current slot via SCI signaling (e.g., SCI-1 or stage-two SCI (SCI-2)).

Additionally, or alternatively, the UE 115-d (e.g., a UE 115 transmitting sidelink signaling) may select a resource pattern of the multiple resource patterns (e.g., for transmission of the sidelink signal 310) based on one or more characteristics of the sidelink signal 310. In some examples, the UE 115-d may select a resource pattern of the multiple resource patterns based on a source ID (e.g., a UE ID for the UE 115-d transmitting the sidelink signal 310), a destination ID (e.g., a UE ID for the UE 115-b receiving the sidelink signal 310 or otherwise indicated as the target of the sidelink signal 310), or both of the sidelink signal 310. In some such examples, the UE 115-b (e.g., a receiving UE 115) may obtain the one or more characteristics of the sidelink signal 310 (e.g., by decoding SCI-1 signaling, SCI-2 signaling, or both from the UE 115-d) to determine (e.g., implicitly) the selected resource pattern. For example, the UE 115-b may use a same selection process as the UE 115-d, such that both the UE 115-d and the UE 115-b may determine a same resource pattern based on the same source ID, destination ID, or both for the sidelink signal 310.

In some cases, a UE 115 monitoring the sidelink channel (e.g., a non-intended recipient of the sidelink signal 310) may receive a detected sidelink signal 315 (e.g., detecting the sidelink signal 310 transmitted via the sidelink channel). For example, the UE 115-c may monitor the sidelink channel in order to contend for sidelink resources, detect sidelink transmissions sent to the UE 115-c, or both. The UE 115-c may receive the detected sidelink signal 315 (e.g., intended for the UE 115-b) and may decode at least a portion (e.g., SCI-1, SCI-2) of the detected sidelink signal 315 to determine the one or more characteristics of the sidelink signal 310 (e.g., source ID, destination ID, or both). For example, based on the destination ID determined for the detected sidelink signal 315, the UE 115-c may determine that the sidelink signal 310 was sent to the UE 115-b (and not the UE 115-c). Accordingly, the UE 115-c may refrain from decoding the rest of the detected sidelink signal 315 based on determining that the UE 115-c is not indicated by the destination ID for the detected sidelink signal 315. The UE 115-c may identify the resources used across a set of sub-slots (e.g., the resource pattern used) for transmission of the sidelink signal 310 based on the one or more characteristics of the sidelink signal 310. As such, if the UE 115-c has a pending sidelink transmission to send, the UE 115-c may select—or otherwise determine—a different resource pattern for transmission of a sidelink signal by the UE 115-c, such that the resources used for the sidelink signal by the UE 115-c do not overlap (e.g., in time and frequency) with the resources used for the sidelink signal 310 by the UE 115-d.

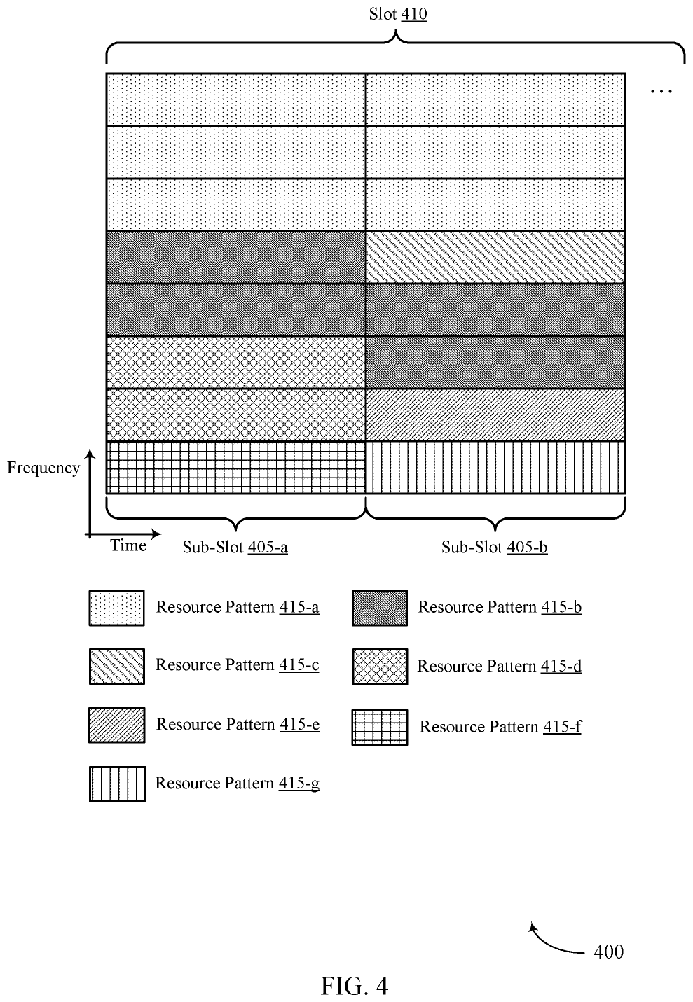

FIG. 4 illustrates an example of a resource pattern configuration 400 that supports resource pattern configuration within a slot for sidelink communication in accordance with one or more aspects of the present disclosure. In some cases, the resource pattern configuration 400 may be implemented by aspects of the wireless communications system 100, the network architecture 200, the wireless communications system 300, or any combination thereof. For example, the resource pattern configuration 400 may configure multiple resource patterns indicated by the resource pattern configuration 305 as described with reference to FIG. 3. The resource pattern configuration 400 may include a first sub-slot 405-a and a second sub-slot 405-b, which may be examples of fractional portions of a slot 410 as described with reference to FIG. 3. Additionally, or alternatively, the sub-slots may be referred to as TTIs or mini-slots.

In some cases, a network entity 105 may configure a resource pool (e.g., including the time-frequency resources of the resource pattern configuration 400) with one or more resource patterns (e.g., the resource pattern 415-a, the resource pattern 415-b, the resource pattern 415-c, the resource pattern 415-d, the resource pattern 415-e, the resource pattern 415-f, the resource pattern 415-g, or any combination thereof). The network entity 105 may allocate one or more subcarriers (e.g., resource blocks) for one or more sub-slots of a set of sub-slots (e.g., the sub-slot 405-a and the sub-slot 405-b) to form a corresponding resource pattern. For example, the network entity 105 may configure the resource pattern 415-a to include three contiguous high-frequency subcarriers for each of the sub-slot 405-a and the sub-slot 405-b. In some cases, the network entity 105 may transmit an indication of the resource pattern configuration 400 to one or more UEs 115 communicating (e.g., scheduling sidelink communications) via sidelink channel resources using the resource pool.

In some examples, the network entity 105 may parameterize the resource patterns by any combination of transport block size, priority information, or quality of service (QoS) information. For example, the network entity 105 may associate the resource pattern 415-a (e.g., including relatively more time-frequency resources than other resource patterns) with a relatively larger transport block size and may associate the resource pattern 415-f (e.g., including relatively fewer time-frequency resources than other resource patterns) with a relatively smaller transport block size. Additionally, or alternatively, the network entity 105 may associate the resource patterns with various priority levels. For instance, a network entity 105 may receive an indication of a logical channel group (LCG) ID for a UE 115 (e.g., a UE 115 that the network entity 105 is configuring for resource grants). The LCG ID may correspond to a QoS threshold for the UE 115, and the network entity 105 may determine a priority level of communications at the UE 115. In some cases, the UE 115 may indicate priority information (e.g., physical layer priority, upper layer priority) for a sidelink signal. For example, the UE 115 may indicate the priority (e.g., corresponding to a QoS value or threshold) of a sidelink transmission in a portion (e.g., three bits) of an SCI signal (e.g., physical layer priority), based on a logical channel priority (e.g., upper layer priority), or a combination thereof. In some examples, the UE 115 may determine one or more parameters of a sidelink signal (e.g., a transport block size, priority information, or both) and may identify a subset of the resource patterns having corresponding parameters (e.g., supporting sidelink signals with the corresponding parameters). In some examples, the UE 115 may select a resource pattern to use for the sidelink transmission from the identified subset. In some other examples, the network entity 105 may assign a resource pattern to the UE 115 from the identified subset of resource patterns.

For example, a UE 115 transmitting a sidelink signal having a relatively large transport block size or a relatively high priority level may determine to select a resource pattern including relatively more time-frequency resources (e.g., the resource pattern 415-a or the resource pattern 415-b corresponding to a larger transport block size, higher priority level, or both) for the sidelink signal. The UE 115 may refrain from selecting resource patterns including relatively fewer time-frequency resources (e.g., the resource pattern 415-c, the resource pattern 415-d, the resource pattern 415-e, the resource pattern 415-f, or the resource pattern 415-g corresponding to a smaller transport block size, lower priority level, or both) for transmission of the sidelink signal based on the parameterization of the resource patterns from the network entity 105.

In some cases, a UE 115 may transmit a sidelink feedback signal in response to receiving a sidelink signal (e.g., via a resource pattern). The UE 115 may determine one or more feedback resources (e.g., PSFCH RBs) for transmission of the sidelink feedback signal by mapping the frequency resources to one or more PSSCH resources of the resource pattern. For example, the UE 115 may use a starting subchannel index and sub-slot index of a first sub-slot 405-a of the resource pattern (e.g., the resource pattern 415-a selected or allocated for sidelink transmission) to determine the one or more PSFCH RBs corresponding to the starting subchannel and sub-slot. Additionally, or alternatively, the UE 115 may use a starting subchannel index and sub-slot index of a last sub-slot 405-b of the resource pattern (e.g., the resource pattern 415-a) to determine the PSFCH RBs for transmitting the sidelink feedback signal. In some cases, a resource pattern may include various quantities of subchannels in a sub-slot (e.g., the resource pattern 415-a may span three subcarriers in both the first sub-slot 405-a and the second sub-slot 405-b), and the UE 115 may determine the PSFCH RBs based on a sub-slot index (e.g., the first sub-slot or the last sub-slot of the resource pattern 415-a) and the quantity of subchannels corresponding to the sub-slot index (e.g., three subchannels for the resource pattern 415-a). The UE 115 may use the determined one or more PSFCH resources for transmission of a sidelink feedback signal (e.g., a HARQ message or other feedback signal indicating positive or negative acknowledgment of successfully receiving a sidelink transmission).

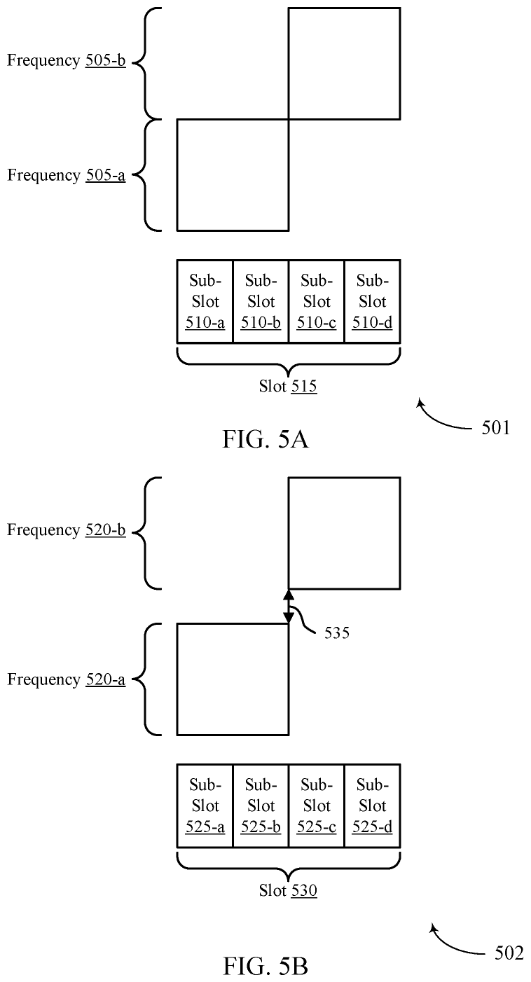

FIGS. 5A and 5B illustrate examples of frequency allocations 501 and 502 that support resource pattern configuration within a slot for sidelink communication in accordance with one or more aspects of the present disclosure. In some cases, the frequency allocations 501 and 502 may be implemented by aspects of the wireless communications system 100, the network architecture 200, the wireless communications system 300, or any combination thereof. For example, the frequency allocations 501 and 502 may each be an example of a resource allocation corresponding to the resource pattern configuration 400, which a UE 115 may use to transmit sidelink signals, as described with reference to FIG. 3. The frequency allocations 501 and 502 may include a quantity of sub-slots within a slot. Additionally, the frequency allocations 501 and 502 may include one or more frequency regions, where a frequency region may be an example of a set of contiguous subcarriers in the frequency domain.

FIG. 5A illustrates an example of a frequency allocation 501, in which a quantity of contiguous sub-slots and contiguous frequencies refer to time-frequency resources allocated for transmission of a sidelink signal. A UE 115 may determine to transmit a sidelink signal at various frequencies (e.g., a frequency 505-a and a frequency 505-b) during fractional portions of a slot 515 (e.g., within one or more sub-slots). For example, the UE 115 may transmit the sidelink signal using resources within the frequency 505-a for a first quantity of sub-slots (e.g., the sub-slot 510-a and the sub-slot 510-b) and may frequency hop to the frequency 505-b for a second (e.g., remaining) quantity of sub-slots (e.g., the sub-slot 510-c and the sub-slot 510-d) of the slot 515. In some cases, the frequency 505-a and the frequency 505-b may be contiguous (e.g., adjacent in the frequency domain). For example, the frequency 505-a may include a first set of contiguous subcarriers in the frequency domain, and the frequency 505-b may include a second set of contiguous subcarriers in the frequency domain. The first set of contiguous subcarriers may be contiguous to the second set of contiguous subcarriers in the frequency domain. A network entity 105 may configure values for the first quantity of sub-slots and the second quantity of sub-slots (e.g., the respective durations for transmitting at each frequency), or may allocate sub-slots of the slot 515 to the respective frequencies evenly or according to some pattern.

FIG. 5B illustrates an example of a frequency allocation 502, in which a quantity of contiguous sub-slots and non-contiguous frequencies refer to time-frequency resources allocated for transmission of a sidelink signal. For example, a UE 115 may determine to transmit a sidelink signal at various frequencies (e.g., a frequency 520-a and a frequency 520-b) during fractional portions of a slot 530 (e.g., within one or more sub-slots). The UE 115 may transmit the sidelink signal via one or more resources of the frequency 520-a for a first quantity of sub-slots (e.g., the sub-slot 525-a and the sub-slot 525-b) and may frequency hop to the frequency 520-b for a second (e.g., remaining) quantity of sub-slots (e.g., the sub-slot 525-c and the sub-slot 525-d) of the slot 530. In some cases, the frequency 520-a and the frequency 520-b may be non-contiguous in the frequency domain. For example, a frequency offset 535 may act as a buffer between the frequency 520-a and the frequency 520-b. In some examples, a network entity 105 configuring the frequency 520-a and the frequency 520-b may configure the frequency offset 535. In some other examples, a UE 115 may configure the frequency offset 535. The frequency offset 535 may span at least a threshold quantity of subcarriers or RBs. A network entity 105 may configure values for the first quantity of sub-slots and the second quantity of sub-slots (e.g., the respective durations for transmitting at each frequency) or may allocate sub-slots of the slot 530 to the respective frequencies evenly or according to a pattern. Additionally, or alternatively, the network entity 105 may configure the frequency offset 535 or may indicate a value (e.g., a pre-defined value) for the frequency offset 535 to the UE 115.

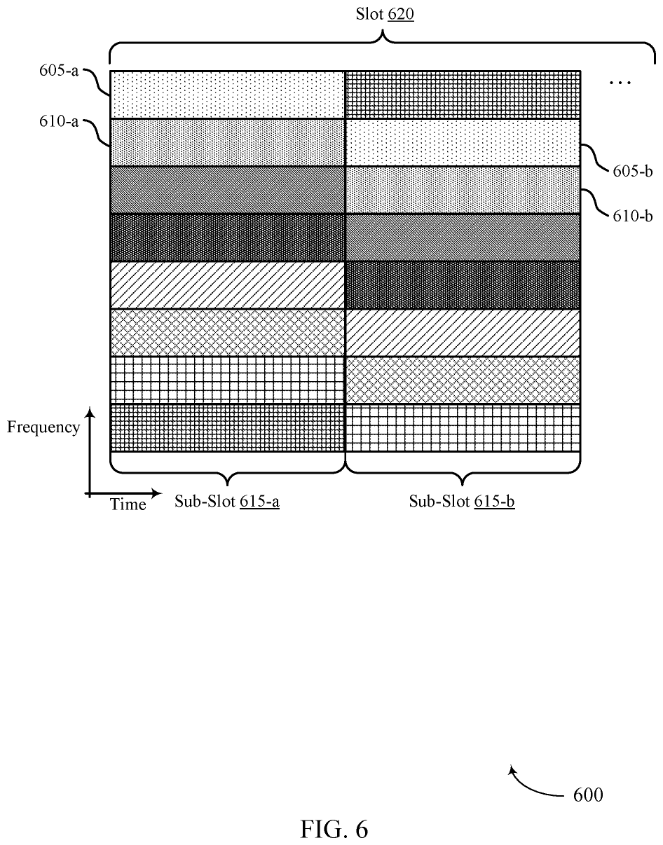

FIG. 6 illustrates an example of a resource pattern configuration 600 that supports resource pattern configuration within a slot for sidelink communication in accordance with one or more aspects of the present disclosure. In some cases, the resource pattern configuration 600 may be implemented by aspects of the wireless communications system 100, the network architecture 200, the wireless communications system 300, or any combination thereof. For example, the resource pattern configuration 600 may be an example of at least a portion of a resource pool configured with multiple resource patterns indicated in a resource pattern configuration 305 or a resource pattern configuration 400 as described with reference to FIGS. 3 and 4. The resource pattern configuration 600 may include a first sub-slot 615-a and a second sub-slot 615-b (e.g., different TTIs), which may be examples of fractional portions of a slot 620 as described with reference to FIGS. 3 and 4. In some cases, the resource pattern configuration 600 may be an example of resource patterns that are based on one or more initial offset values.

In some cases, a network entity 105 may configure a resource pool (e.g., including the time-frequency resources of resource pattern configuration 600) with multiple resource patterns based on an initial frequency position. That is, the network entity 105 may configure the resource pool to include resource patterns which incrementally change in frequency at each sub-slot boundary (e.g., according to a “staircase” pattern). For example, a first resource pattern may include a first resource 605-a (e.g., a first subcarrier or set of subcarriers during the first sub-slot 615-a) and may include a second resource 605-b (e.g., a second subcarrier or set of subcarriers during the second sub-slot 615-b) having a frequency position different than that of the first resource 605-a (e.g., in accordance with a subchannel hop). In some cases, an index of a given sub-slot may correspond to a function (e.g., a modulo function) of a starting subchannel index (e.g., i_start), a quantity of hops (e.g., k), and a total number of subchannels in the resource pool.

A UE 115 may select—or be assigned—an initial resource (e.g., a subchannel or set of subchannels) for transmitting over a set of sub-slots (e.g., the sub-slot 615-a and the sub-slot 615-b within the slot 620) based on one or more initial offset values and a configured pattern (e.g., the staircase pattern). In some cases, the UE 115 may identify a set of offset values corresponding to multiple subcarriers of a sub-slot. For example, the UE 115 may determine to transmit a first portion of a sidelink signal during the sub-slot 615-a via the first resource 605-a and the first resource 610-a based on the set of offset values including values corresponding to the first resource 605-a and the first resource 610-a (e.g., an offset value ‘0’ and an offset value ‘1’ for the resource pool). The UE 115 may transmit a second portion of the sidelink signal during the sub-slot 615-b via the second resource 605-b and the second resource 610-b based on the staircase pattern. For example, if a first subchannel index is used for the sidelink transmission in a first sub-slot 615-a, the UE 115 may increment the first subchannel index at the sub-slot boundary to obtain a second subchannel index to use for the sidelink transmission in a second sub-slot 615-b.

In some examples, the UE 115 (e.g., a UE 115 reserving sidelink resources for a sidelink transmission) may receive control signaling indicating the set of offset values (e.g., one or more offset values corresponding to one or more subchannels in an initial sub-slot 615-a) for determining a resource pattern for transmission of a sidelink signal. For example, a first UE 115 may receive, from a second UE 115, an RRC message, a MAC-CE, an SCI signal, or any other control signaling (e.g., over a PC5 interface) indicating the set of offset values available for the first UE 115. In some cases, a network entity 105 may configure (e.g., assign) one or more UEs 115 with a respective set of offset values for a corresponding resource pool, and the network entity 105 may transmit a control signal (e.g., an RRC signal, a MAC-CE, a DCI signal) indicating the set of offset values for a UE 115 or a set of UEs 115. For example, the network entity 105 may configure a first UE 115 with one or more UE-specific offset values, such that other UEs 115 may not use the same offset values as the first UE 115. In some such cases, UEs 115 may be aware of the set of offset values assigned to the other UEs 115 (e.g., to avoid collisions between UE offset selections). In some other examples, the network entity 105 may configure multiple sets of offset values (e.g., K potential offset patterns) common to a corresponding resource pool. A UE 115 may select a set of offset values of the multiple sets of offset values common to the resource pool and may perform sidelink communications in accordance with the pattern (e.g., one or more resource patterns) associated with the set of offset values. Additionally, or alternatively, the UE 115 may identify one or more parameters (e.g., a source ID, a destination ID, or both) associated with a sidelink signal and may determine a set of offset values based on the one or more parameters or a function (e.g., a modulo operation) of the one or more parameters and a quantity of the multiple sets of offset values. In some such examples, a UE 115 receiving the sidelink signal may decode control information for the sidelink signal (e.g., SCI-1, SCI-2) in order to determine the one or more parameters and identify the resource pattern or patterns used for transmission of the sidelink signal.

In some examples, a first UE 115 may indicate the set of initial offset values (e.g., selected by the UE 115 or assigned to the UE 115) to one or more other UEs 115. For example, the first UE 115 may indicate the set of initial offset values to the one or more other UEs 115 via a field in sidelink signaling (e.g., an SCI field indicating one or more offset values). Additionally, or alternatively, the first UE 115 may indicate the set of offset values via a bitmap in a control signal (e.g., SCI-1, SCI-2). For instance, a network entity 105 may configure one or more bitmaps for a corresponding resource pool, and the first UE 115 may select a bitmap (e.g., select bit values to include in the bitmap) to indicate the initial offsets of a sidelink transmission in the control signal to the one or more other UEs 115. In some cases, the first UE 115 may indicate a first offset value (e.g., the first value of the set of initial offset values) and a quantity of subchannels. The one or more other UEs 115 may use this information to determine that a first subchannel (e.g., corresponding to the first offset value) and a quantity of subchannels contiguous to the first subchannel (e.g., corresponding to the quantity of subchannels) are reserved by the first UE 115 for sidelink transmissions. Other UEs 115 receiving the indication of the set of initial offset values may determine which resources are reserved by the UE 115. The other UEs 115 may use this information to successfully receive the sidelink signal transmitted by the UE 115, to select other, non-overlapping resources for sidelink transmissions (e.g., resources corresponding to different offset values or different sub-slots in the resource pool), or both.

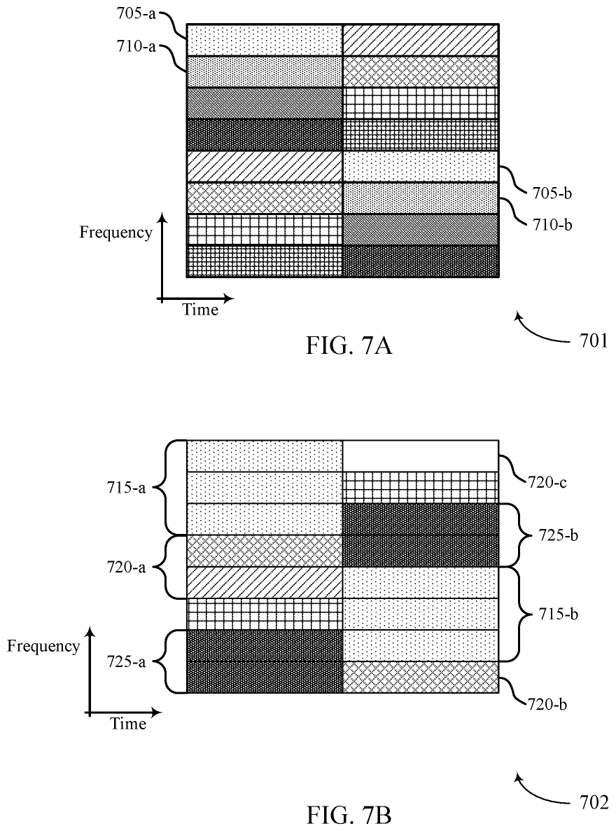

FIGS. 7A and 7B illustrate examples of resource pattern configurations 701 and 702 that support resource pattern configuration within a slot for sidelink communication in accordance with one or more aspects of the present disclosure. In some cases, the resource pattern configurations 701 and 702 may be implemented by aspects of the wireless communications system 100, the network architecture 200, the wireless communications system 300, or any combination thereof. For example, the resource pattern configurations 701 and 702 may be examples of at least a portion of a resource pool configured with multiple resource patterns indicated by the resource pattern configuration 305, the resource pattern configuration 400, or the resource pattern configuration 600 as described with reference to FIGS. 3, 4, and 6. The resource pattern configurations 701 and 702 may include one or more resource patterns configured in accordance with a “bit reversal permutation” technique for resource assignment.

FIG. 7A illustrates a resource pattern configuration 701 that configures multiple resource patterns. The resource patterns of the resource pattern configuration 701 may be configured in accordance with a bit reversal permutation technique for resource assignment and an initial offset value. For example, a UE 115 may determine an initial offset value using techniques as described herein with reference to FIG. 6. For example, the UE 115 may select one or more initial offset values, determine the one or more initial offset values based on parameters of a sidelink signal, receive an assignment of the one or more initial offset values (e.g., from a network entity 105 or from another UE 115), or any combination thereof.

In some cases, the UE 115 may associate each element of a transmission sequence (e.g., corresponding to a respective sub-slot) with an index value, and may determine the frequency position of each element based on reversing the binary representation of the index value, the one or more initial offset values, or both. For example, the UE 115 may assign a first index element (e.g., the sub-slot including the resource 705-a) with a first index value (e.g., index 0), a second index element (e.g., the sub-slot including the resource 705-b) with a second index value (e.g., index 1), and may continue to assign elements of the transmission sequence with index values for a remaining quantity of available subchannels or until the transmission sequence completes. In some cases, the quantity of elements in the transmission sequence may correspond to the number of bits used for indexing the elements of the transmission sequence (e.g., a power of two). Additionally, or alternatively, the UE 115 may pad the binary representation of an index value based on the number of bits used for indexing the elements of the transmission sequence (e.g., a binary ‘1’ including two leading zeros for a three-bit index).

The UE 115 may determine a frequency resource (e.g., subchannel) at each sub-slot of the resource pattern based on an initial offset value and by performing a bit-reversal permutation on the index value assigned to a respective transmission sequence element corresponding to each sub-slot. For example, the UE 115 may identify a resource pattern corresponding to an 8 element sequence, and may also determine to use an initial offset value of 0 (e.g., in accordance with signaling techniques as described with reference to FIG. 6). In such an example, the UE 115 may identify the binary representation of the index value associated with a sub-slot (e.g., index value 1 represented as ‘001’), reverse the order of bits in the binary representation (e.g., represented as ‘100’), and assign a frequency resource for the transmission sequence element based on the bit reversal (e.g., corresponding to the decimal value ‘4’) and the starting offset (e.g., the sum of the decimal value corresponding to the bit reversal and the starting offset). In some cases, the UE 115 may continue to perform the bit reversal permutation to generate a sequence of frequency positions for each element of the transmission sequence for a quantity of available sub-slots (e.g., the resource 705-a at subcarrier 0 and the resource 705-b at subcarrier 4). The UE 115 may identify a resource pattern by applying frequency positions for each element of the transmission sequence for a number of available sub-slots (e.g., two sub-slots) in accordance with the bit reversal permutation technique. Similarly, a UE 115 may use the resource pattern corresponding to the resource 710-a and the resource 710-b based on an initial offset value and the bit reversal technique.

FIG. 7B illustrates a resource pattern configuration 702 that configures multiple resource patterns. The resource patterns of the resource pattern configuration 702 may be configured in accordance with a bit reversal permutation technique for resource assignment and one or more initial offset values (e.g., an initial offset value or a set of initial offset values). For example, a UE 115 may determine one or more initial offset values using techniques as described with reference to FIG. 6 (e.g., configured by a network entity 105). In some cases, the UE 115 may perform a bit reversal permutation to determine frequency resources (e.g., for each offset value of the one or more initial offset values) at each sub-slot as described with reference to FIG. 7A. For example, a first UE 115 may determine to use a resource pattern including resources 715-a and resources 715-b based on the one or more initial offset values for the first UE 115 (e.g., an initial offset value ‘0,’ an initial offset value ‘1,’ and an initial offset value ‘2’), a second UE 115 may determine to use the resource pattern including resources 720-a, resource 720-b, and resource 720-c based on the one or more initial offset values for the second UE 115 (e.g., an initial offset value ‘6’ and an initial offset value ‘7’), and a third UE 115 may determine to use the resource pattern including resources 725-a and resources 725-b based on the one or more initial offset values for the third UE 115 (e.g., an initial offset value ‘3’ and an initial offset value ‘4’).

In some cases, two or more subchannels of a resource pattern (e.g., a resource pattern associated with the bit-reversal permutation technique) at a sub-slot may be non-contiguous (e.g., separated in the frequency domain). For example, a UE 115 (e.g., the third UE 115 performing communications according to the initial offset values ‘6’ and ‘7’) may determine that the resource 720-c and the resource 720-b are non-contiguous in frequency (e.g., in a same sub-slot). In some examples, the UE 115 may determine to use (e.g., communicate via) each of the non-contiguous resources (e.g., via the resource 720-c and the resource 720-b) in accordance with the resource pattern. For example, the UE 115 may perform a transport block transmission at the resource 720-b and may repeat the transport block transmission at the resource 720-c. In some cases, the UE 115 may perform a first transport block transmission at the resource 720-b and may perform a second transport block transmission (e.g., a new transport block) at the resource 720-c.

Additionally, or alternatively, the UE 115 may determine to refrain from transmitting on (e.g., drop) one or more of the non-contiguous resources. For example, the UE 115 may determine to drop a resource having a higher frequency position (e.g., the resource 720-c) or may determine to drop the resource having a lower frequency position (e.g., the resource 720-b). In some examples, the UE 115 may drop resources according to any rule or metric. In some cases, the UE 115 may determine resources to drop based on one or more channel quality metrics (e.g., a peak-to-average power ratio (PAPR)). In some other cases, the UE 115 may drop each non-contiguous resource (e.g., based on the capability of the UE 115). In some examples, one or more resources dropped by a UE 115 may remain unused (e.g., not used by another UE 115 scheduling resources with the bit reversal permutation), and a network entity 105 may assign the unused resources to one or more UEs 115 (e.g., the UEs 115 utilizing the resource pool). For example, the network entity 105 may assign the remaining (e.g., dropped) resources to the one or more UEs 115 (e.g., in a mode-1 allocation scheme) via an indication in a control signal (e.g., an RRC signal, a MAC-CE, DCI). Accordingly, a UE 115 may transmit sidelink signaling according to one or more resource patterns, one or more specifically assigned resources dropped from other resources patterns, or any combination thereof.

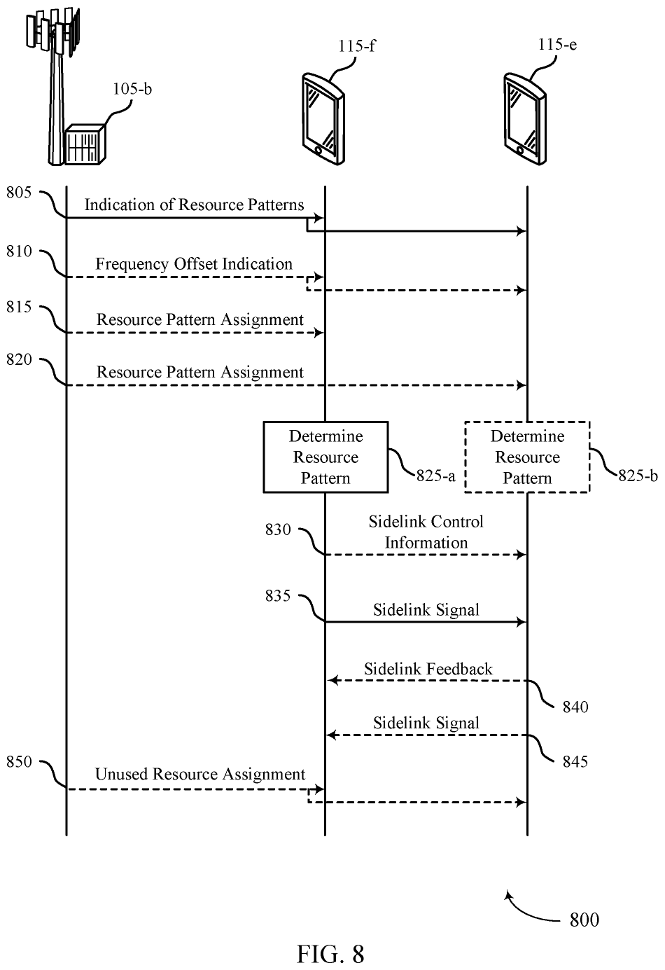

FIG. 8 illustrates an example of a process flow 800 that supports resource pattern configuration within a slot for sidelink communication in accordance with one or more aspects of the present disclosure. The process flow 800 may be implemented by a network entity 105-b, a UE 115-e, and a UE 115-f, which may be examples of a network entity 105 and UEs 115 as described with reference to FIGS. 1 through 7B. In some examples, some signaling or procedures of the process flow 800 may occur in different orders than shown. Additionally, or alternatively, additional procedures or signaling may occur, or some signaling or procedures may not occur.

At 805, the network entity 105-b may transmit a control signal (e.g., RRC, DCI, MAC-CE) including an indication of resource patterns (e.g., indicative of a set of time-frequency resources) to one or more UEs 115. For example, the network entity 105-b may configure multiple resource patterns for a resource pool. In some cases, the UE 115-e and the UE 115-f may be UEs 115 communicating via sidelink and may each receive the indication of resource patterns for a resource pool (e.g., resources for sidelink communications). In some cases, the network entity 105-b may configure the multiple resource patterns to correspond to various transport block sizes, various priority levels, or both. For example, a resource pattern may correspond to a specific transport block size or range of transport block sizes, a specific priority level or range of priority levels, or a combination thereof.

In some examples, at 810, the network entity 105-b may transmit a control signal including a frequency offset indication to the UE 115-f, the UE 115-e, or both. In some cases, the frequency offset indication may include one or more frequency offset values for the UEs 115. For example, the frequency offset indication may include a set of offset values, and each offset value of the set of offset values may indicate an assigned set of resources for sidelink communications (e.g., a resource pattern based on the offset value). The UE 115-f, the UE 115-e, or both may identify one or more offset values to use for transmitting sidelink signals. For example, a UE 115 may identify a respective assigned offset value (e.g., a UE-specific offset value) or may identify an offset value common to the UE 115-f and the UE 115-e. Additionally, or alternatively, a UE 115 may identify a set of one or more offset values to use for communicating sidelink signals. In some cases, the frequency offset indication may support a staircase technique for resource assignment (e.g., as described with reference to FIG. 6) or a bit reversal permutation technique for resource assignment (e.g., as described with reference to FIG. 7A).

In some examples, at 815, the network entity 105-b may transmit a control signal assigning a resource pattern to the UE 115-f For example, the UE 115-f may, in response to receiving the resource pattern assignment, determine a resource pattern of the multiple resource patterns to use for transmitting a sidelink signal.

In some examples, at 820, the network entity 105-b may additionally transmit a control signal assigning a resource pattern to the UE 115-e. For example, the UE 115-e may, in response to receiving the resource pattern assignment, determine a resource pattern of the multiple resource patterns to use for transmitting a sidelink signal.

At 825, the UEs 115 may determine resource patterns to use for transmitting sidelink signaling over a set of TTIs within a slot (e.g., fractional portions of a slot, such as sub-slots or mini-slots). For example, at 825-a, the UE 115-f may determine a resource pattern to use based on the frequency offset indication, the resource pattern assignment, a source ID for a sidelink signal, a destination ID for a sidelink signal, or any combination thereof. At 825-b, the UE 115-e may determine a resource pattern using similar information (e.g., specific to the UE 115-e).

In some examples, at 830, the UE 115-f may transmit an SCI message to the UE 115-e. In some cases, the SCI message (e.g., an SCI-1 message or an SCI-2 message) may indicate the resource pattern determined by the UE 115-f for transmission of a sidelink signal. For example, the UE 115-f may determine a resource pattern based on one or more frequency offset values or an assignment by the network entity 105-b and may include an explicit indication of the resource pattern in the SCI message (e.g., via SCI-1 or SCI-2). For example, the explicit indication may be an example of a field indicating the resource pattern using a resource pattern index, a bitmap, or some other indication. Additionally, or alternatively, the UE 115-f may determine a resource pattern based on a source ID for the sidelink signal, a destination ID for the sidelink signal, or both, and the UE 115-e may determine the resource pattern by decoding information in the SCI message (e.g., an SCI-2 message), such as the source ID, the destination ID, or both. In some other examples, the SCI message may include a bit map indicating one or more initial offset values for the sidelink signal, which the UE 115-e may use to determine the resource pattern. In some cases, a third UE 115 within the wireless communications system may be listening to ongoing sidelink communications and may detect the SCI message. For example, the UE 115 may detect and decode the SCI message to determine which resources are allocated to the resource pattern (e.g., and are therefore unavailable to the third UE 115).

At 835, the UE 115-f may transmit a sidelink signal to the UE 115-e in accordance with the determined resource pattern. For example, the UE 115-f may transmit the sidelink signal over a set of resources including a quantity of TTIs (e.g., fractional portions of a slot, a quantity of symbols) and respective frequency resources (e.g., subchannels) according to the determined resource pattern.

In some examples, at 840, the UE 115-e may transmit, to the UE 115-f, a sidelink feedback signal via one or more sidelink feedback channel resources (e.g., PSFCH RBs). In some cases, the UE 115-e may determine the sidelink feedback channel resources based on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof.

In some cases, at 845, the UE 115-e may transmit, to the UE 115-f or another UE 115, a sidelink signal in accordance with the determined resource pattern (e.g., at 825-b). In some examples, the UE 115-e may transmit the sidelink signal according to a resource pattern that is different from the resource pattern used by the UE 115-f.

In some examples, at 850, the network entity 105-b may transmit, to the UE 115-f and the UE 115-e, a control signal including an assignment of unused resources. For example, the UEs 115 may drop non-contiguous subcarrier resources in a same TTI (e.g., sub-slot) for a determined resource pattern (e.g., due to UE capability, channel quality, or both). The network entity 105-b may identify the remaining available resources, and may assign the resources (e.g., a subcarrier, a set of subcarriers, multiple sets of subcarriers) to one or more UEs 115. For example, the network entity 105-b may assign the resources to the same UEs 115 (e.g., the UE 115-f and the UE 115-e communicating via resource patterns) or may assign the resources to different UEs 115.

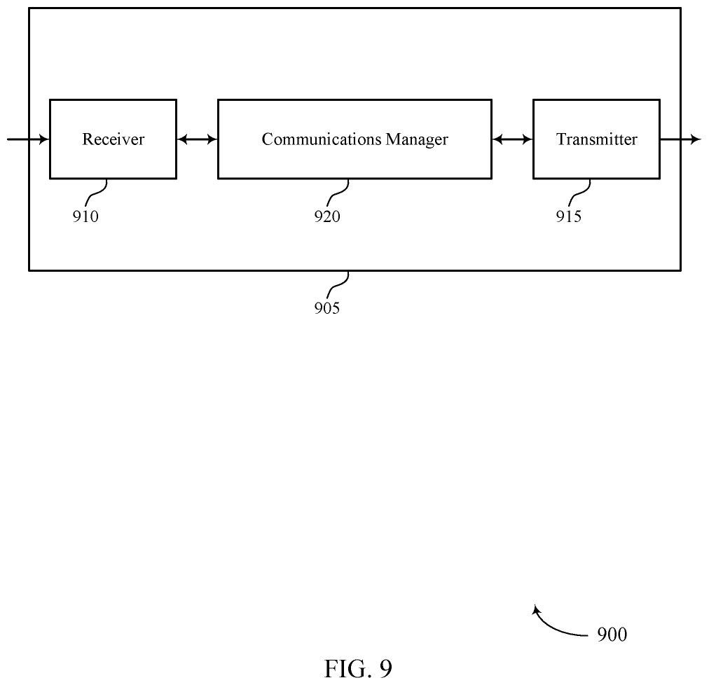

FIG. 9 shows a block diagram 900 of a device 905 that supports resource pattern configuration within a slot for sidelink communication in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to resource pattern configuration within a slot for sidelink communication). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to resource pattern configuration within a slot for sidelink communication). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of resource pattern configuration within a slot for sidelink communication as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. For example, the communications manager 920 may be configured as or otherwise support a means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals (e.g., sub-slots) within a slot. The communications manager 920 may be configured as or otherwise support a means for transmitting a sidelink signal via the set of resources corresponding to the resource pattern of the set of multiple resource patterns based on the control signal.

Additionally, or alternatively, the communications manager 920 may support wireless communications at a UE in accordance with examples as disclosed herein. For example, the communications manager 920 may be configured as or otherwise support a means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals (e.g., sub-slots) within a slot. The communications manager 920 may be configured as or otherwise support a means for detecting a sidelink signal via the set of resources corresponding to the resource pattern of the set of multiple resource patterns based on the control signal. The communications manager 920 may be configured as or otherwise support a means for communicating based on the resource pattern for the detected sidelink signal.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for efficient resource utilization and allocation and reduced power consumption related to sidelink resource reservation and indication.

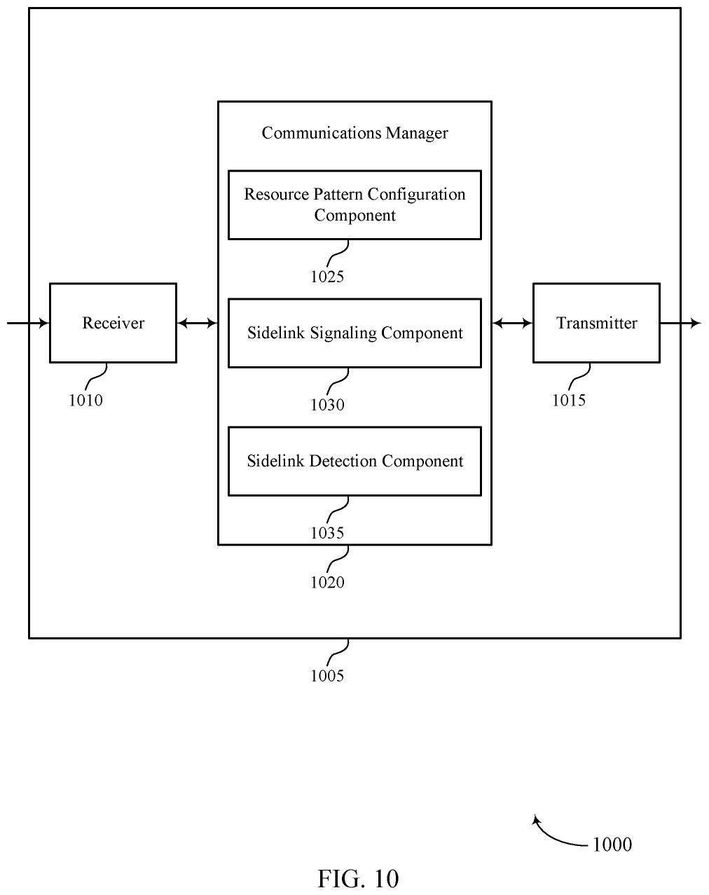

FIG. 10 shows a block diagram 1000 of a device 1005 that supports resource pattern configuration within a slot for sidelink communication in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to resource pattern configuration within a slot for sidelink communication). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to resource pattern configuration within a slot for sidelink communication). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of resource pattern configuration within a slot for sidelink communication as described herein. For example, the communications manager 1020 may include a resource pattern configuration component 1025, a sidelink signaling component 1030, a sidelink detection component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The resource pattern configuration component 1025 may be configured as or otherwise support a means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The sidelink signaling component 1030 may be configured as or otherwise support a means for transmitting a sidelink signal via the set of resources corresponding to the resource pattern of the set of multiple resource patterns based on the control signal.

Additionally, or alternatively, the communications manager 1020 may support wireless communications at a UE in accordance with examples as disclosed herein. The resource pattern configuration component 1025 may be configured as or otherwise support a means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The sidelink detection component 1035 may be configured as or otherwise support a means for detecting a sidelink signal via the set of resources corresponding to the resource pattern of the set of multiple resource patterns based on the control signal. The sidelink signaling component 1030 may be configured as or otherwise support a means for communicating based on the resource pattern for the detected sidelink signal.

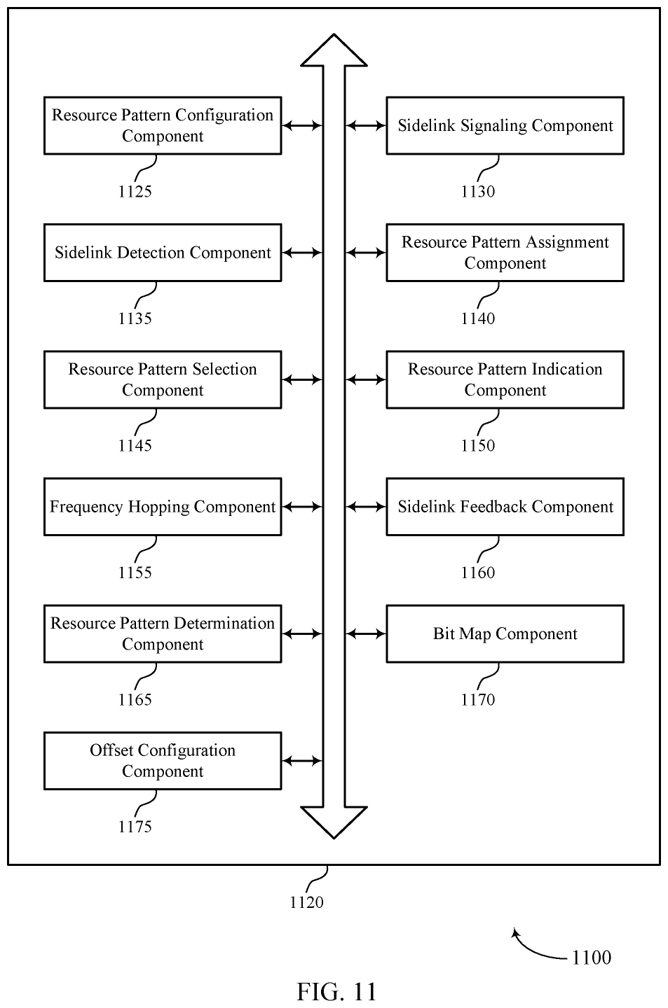

FIG. 11 shows a block diagram 1100 of a communications manager 1120 that supports resource pattern configuration within a slot for sidelink communication in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of resource pattern configuration within a slot for sidelink communication as described herein. For example, the communications manager 1120 may include a resource pattern configuration component 1125, a sidelink signaling component 1130, a sidelink detection component 1135, a resource pattern assignment component 1140, a resource pattern selection component 1145, a resource pattern indication component 1150, a frequency hopping component 1155, a sidelink feedback component 1160, a resource pattern determination component 1165, a bit map component 1170, an offset configuration component 1175, or any combination thereof. Each of these components may communicate, directly or indirectly, with one another (e.g., via one or more buses).

The communications manager 1120 may support wireless communications at a UE in accordance with examples as disclosed herein. The resource pattern configuration component 1125 may be configured as or otherwise support a means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The sidelink signaling component 1130 may be configured as or otherwise support a means for transmitting a sidelink signal via the set of resources corresponding to the resource pattern of the set of multiple resource patterns based on the control signal.

In some examples, the resource pattern assignment component 1140 may be configured as or otherwise support a means for receiving a second control signal assigning the resource pattern of the set of multiple resource patterns to the UE, where the sidelink signal is transmitted via the set of resources corresponding to the resource pattern based on the second control signal.

In some examples, the resource pattern selection component 1145 may be configured as or otherwise support a means for determining the resource pattern from the set of multiple resource patterns based on a source identifier for the sidelink signal, a destination identifier for the sidelink signal, or both, where the sidelink signal is transmitted via the set of resources corresponding to the resource pattern based on the determining.

In some examples, the resource pattern indication component 1150 may be configured as or otherwise support a means for transmitting a sidelink control signal indicating the resource pattern based on transmitting the sidelink signal via the set of resources corresponding to the resource pattern.

In some examples, the set of multiple resource patterns corresponds to a set of multiple transport block sizes, a set of multiple transmission priorities, or both. In some examples, the resource pattern of the set of multiple resource patterns corresponds to a transport block size for the sidelink signal, a transmission priority for the sidelink signal, or both.

In some examples, to support transmitting the sidelink signal, the frequency hopping component 1155 may be configured as or otherwise support a means for performing frequency hopping for transmission of the sidelink signal from a first set of subcarriers during a first sub-slot of the slot to a second set of subcarriers different from the first set of subcarriers during a second sub-slot of the slot based on the resource pattern, where the different transmission time intervals include the first sub-slot and the second sub-slot.

In some examples, the first set of subcarriers is separated from the second set of subcarriers in frequency by a frequency offset.

In some examples, to support transmitting the sidelink signal, the sidelink signaling component 1130 may be configured as or otherwise support a means for transmitting a first portion of the sidelink signal during a first sub-slot of the slot via a first set of subcarriers associated with a first resource index based on one or more initial offset values. In some examples, to support transmitting the sidelink signal, the sidelink signaling component 1130 may be configured as or otherwise support a means for transmitting a second portion of the sidelink signal during a second sub-slot of the slot via a second set of subcarriers associated with a second resource index based on the first resource index, where the different transmission time intervals include the first sub-slot and the second sub-slot.

In some examples, the offset configuration component 1175 may be configured as or otherwise support a means for receiving a second control signal indicating a set of offset values, where the one or more initial offset values are based on the set of offset values.

In some examples, an offset value of the set of offset values is common across UEs for the resource pool or is specific to the UE for the resource pool.

In some examples, the bit map component 1170 may be configured as or otherwise support a means for transmitting a sidelink control signal including a bit map indicating the one or more initial offset values based on transmitting the first portion of the sidelink signal via the first set of subcarriers associated with the first resource index based on the one or more initial offset values.

In some examples, the second resource index is based on the first resource index and a staircase technique for resource assignment or a bit reversal permutation technique for resource assignment.

In some examples, the resource pattern indicates, for the UE, a first set of subcarriers and a second set of subcarriers non-contiguous in frequency within a sub-slot and, to support transmitting the sidelink signal, the sidelink signaling component 1130 may be configured as or otherwise support a means for refraining from transmitting a portion of the sidelink signal via the second set of subcarriers based on the second set of subcarriers being non-contiguous in frequency with the first set of subcarriers. In some examples, the sidelink signaling component 1130 may be configured as or otherwise support a means for repeating a transport block transmission via the second set of subcarriers based on the second set of subcarriers being non-contiguous in frequency with the first set of subcarriers. In some examples, the sidelink signaling component 1130 may be configured as or otherwise support a means for transmitting a first transport block via the first set of subcarriers and transmitting a second transport block via the second set of subcarriers based on the second set of subcarriers being non-contiguous in frequency with the first set of subcarriers, where the different transmission time intervals include the sub-slot.

In some examples, the sidelink feedback component 1160 may be configured as or otherwise support a means for receiving, in response to the sidelink signal, a sidelink feedback signal via sidelink feedback channel resources, where the sidelink feedback channel resources are based on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof, where the different transmission time intervals include the first sub-slot and the last sub-slot.

Additionally, or alternatively, the communications manager 1120 may support wireless communications at a UE in accordance with examples as disclosed herein. In some examples, the resource pattern configuration component 1125 may be configured as or otherwise support a means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The sidelink detection component 1135 may be configured as or otherwise support a means for detecting a sidelink signal via the set of resources corresponding to the resource pattern of the set of multiple resource patterns based on the control signal. In some examples, the sidelink signaling component 1130 may be configured as or otherwise support a means for communicating based on the resource pattern for the detected sidelink signal.

In some examples, to support communicating, the sidelink signaling component 1130 may be configured as or otherwise support a means for receiving the sidelink signal based on the resource pattern.

In some examples, the sidelink feedback component 1160 may be configured as or otherwise support a means for transmitting, in response to the sidelink signal, a sidelink feedback signal via sidelink feedback channel resources, where the sidelink feedback channel resources are based on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof, where the different transmission time intervals include the first sub-slot and the last sub-slot.

In some examples, to support communicating, the sidelink signaling component 1130 may be configured as or otherwise support a means for transmitting a second sidelink signal via a second set of resources corresponding to a second resource pattern of the set of multiple resource patterns based on the resource pattern for the detected sidelink signal.

In some examples, to support detecting the sidelink signal, the resource pattern indication component 1150 may be configured as or otherwise support a means for receiving a sidelink control signal associated with the sidelink signal and indicating the resource pattern for the sidelink signal.

In some examples, the resource pattern determination component 1165 may be configured as or otherwise support a means for determining the resource pattern for the sidelink signal based on a source identifier for the sidelink signal, a destination identifier for the sidelink signal, or both.

In some examples, to support detecting the sidelink signal, the bit map component 1170 may be configured as or otherwise support a means for receiving a sidelink control signal associated with the sidelink signal and including a bit map indicating one or more initial offset values for the sidelink signal. In some examples, to support detecting the sidelink signal, the bit map component 1170 may be configured as or otherwise support a means for determining the set of resources corresponding to the resource pattern for the sidelink signal based on the bit map.

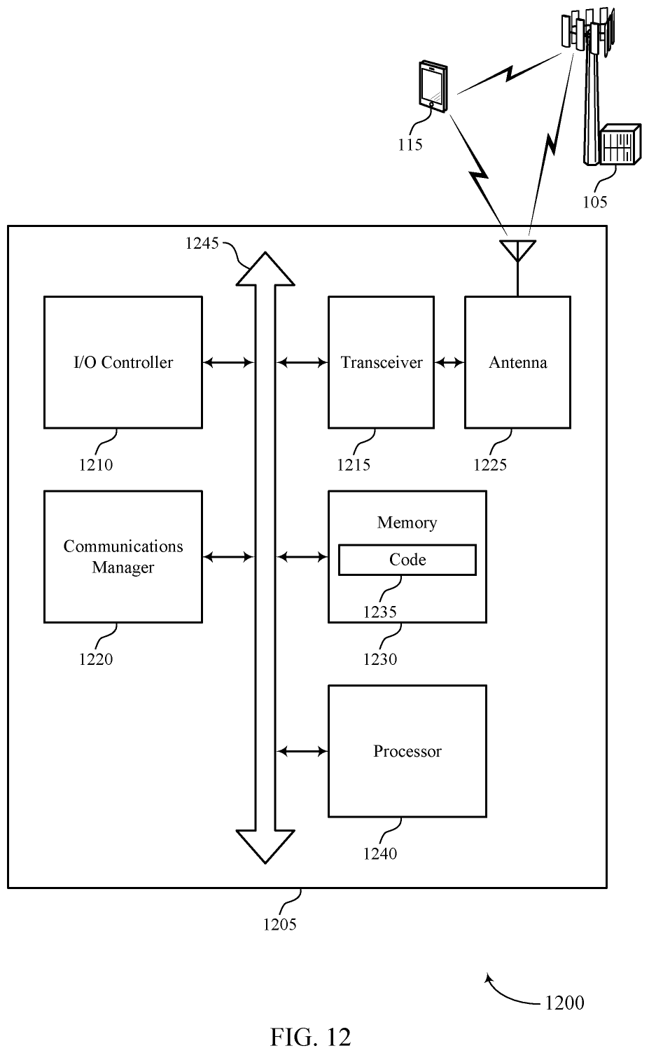

FIG. 12 shows a diagram of a system 1200 including a device 1205 that supports resource pattern configuration within a slot for sidelink communication in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting resource pattern configuration within a slot for sidelink communication). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The communications manager 1220 may be configured as or otherwise support a means for transmitting a sidelink signal via the set of resources corresponding to the resource pattern of the set of multiple resource patterns based on the control signal.

Additionally, or alternatively, the communications manager 1220 may support wireless communications at a UE in accordance with examples as disclosed herein. For example, the communications manager 1220 may be configured as or otherwise support a means for receiving a control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The communications manager 1220 may be configured as or otherwise support a means for detecting a sidelink signal via the set of resources corresponding to the resource pattern of the set of multiple resource patterns based on the control signal. The communications manager 1220 may be configured as or otherwise support a means for communicating based on the resource pattern for the detected sidelink signal.

By including or configuring the communications manager 1220 in accordance with examples as described herein, the device 1205 may support techniques for efficient sidelink resource scheduling and reduced power consumption related to sidelink resource assignment, selection, indication, or some combination thereof.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of resource pattern configuration within a slot for sidelink communication as described herein, or the processor 1240 and the memory 1230 may be otherwise configured to perform or support such operations.

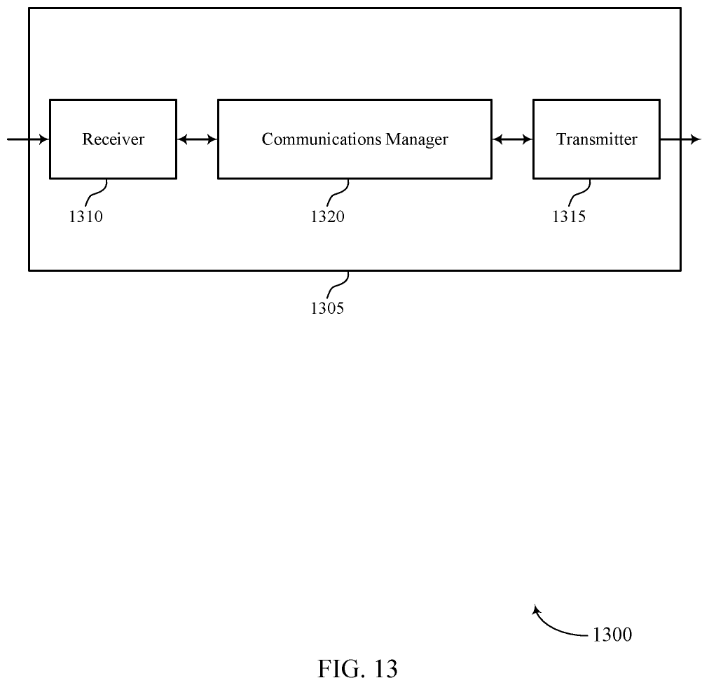

FIG. 13 shows a block diagram 1300 of a device 1305 that supports resource pattern configuration within a slot for sidelink communication in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of resource pattern configuration within a slot for sidelink communication as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. For example, the communications manager 1320 may be configured as or otherwise support a means for transmitting a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals (e.g., sub-slots) within a slot. The communications manager 1320 may be configured as or otherwise support a means for transmitting a second control signal assigning a first resource pattern of the set of multiple resource patterns to a first UE for sidelink communication within the slot. The communications manager 1320 may be configured as or otherwise support a means for transmitting a third control signal assigning a second resource pattern of the set of multiple resource patterns to a second UE for sidelink communication within the slot.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for efficient sidelink resource configuration and assignment.

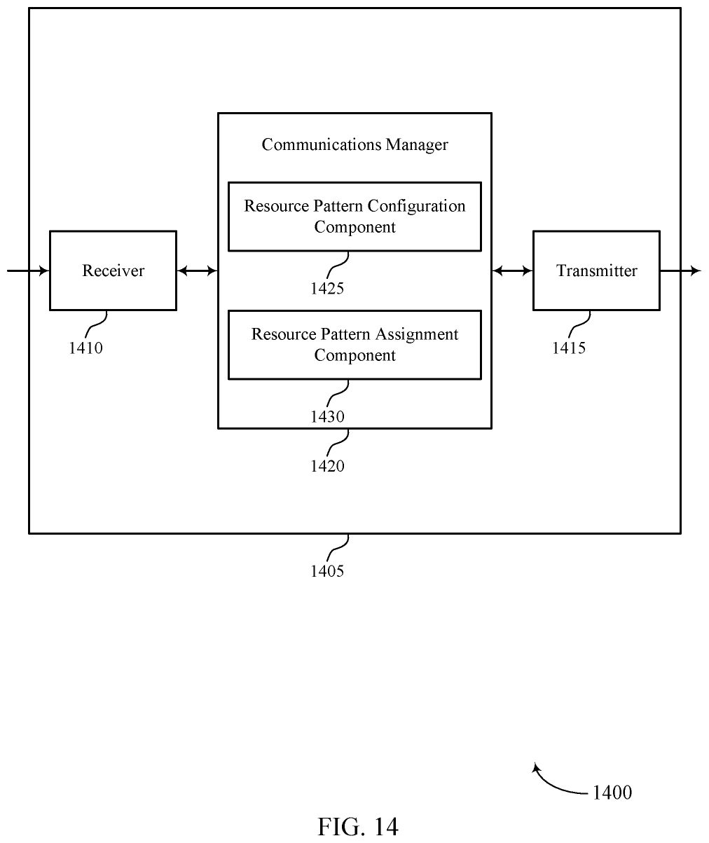

FIG. 14 shows a block diagram 1400 of a device 1405 that supports resource pattern configuration within a slot for sidelink communication in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of resource pattern configuration within a slot for sidelink communication as described herein. For example, the communications manager 1420 may include a resource pattern configuration component 1425 a resource pattern assignment component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. The resource pattern configuration component 1425 may be configured as or otherwise support a means for transmitting a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The resource pattern assignment component 1430 may be configured as or otherwise support a means for transmitting a second control signal assigning a first resource pattern of the set of multiple resource patterns to a first UE for sidelink communication within the slot. The resource pattern assignment component 1430 may be configured as or otherwise support a means for transmitting a third control signal assigning a second resource pattern of the set of multiple resource patterns to a second UE for sidelink communication within the slot.

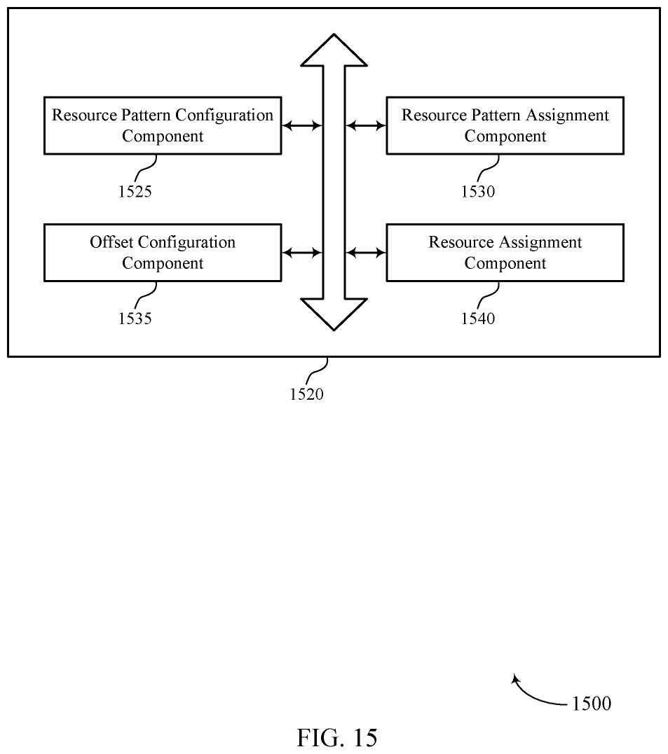

FIG. 15 shows a block diagram 1500 of a communications manager 1520 that supports resource pattern configuration within a slot for sidelink communication in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of resource pattern configuration within a slot for sidelink communication as described herein. For example, the communications manager 1520 may include a resource pattern configuration component 1525, a resource pattern assignment component 1530, an offset configuration component 1535, a resource assignment component 1540, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a network entity in accordance with examples as disclosed herein. The resource pattern configuration component 1525 may be configured as or otherwise support a means for transmitting a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The resource pattern assignment component 1530 may be configured as or otherwise support a means for transmitting a second control signal assigning a first resource pattern of the set of multiple resource patterns to a first UE for sidelink communication within the slot. In some examples, the resource pattern assignment component 1530 may be configured as or otherwise support a means for transmitting a third control signal assigning a second resource pattern of the set of multiple resource patterns to a second UE for sidelink communication within the slot.

In some examples, the offset configuration component 1535 may be configured as or otherwise support a means for transmitting a fourth control signal indicating a set of offset values for the first UE and the second UE, where an offset value of the set of offset values indicates an assigned set of resources for sidelink communication based on an assigned resource pattern.

In some examples, the set of offset values includes a first offset value specific to the first UE for the resource pool, a second offset value specific to the second UE for the resource pool, a third offset value common to the first UE and the second UE for the resource pool, or any combination thereof.

In some examples, the first resource pattern indicates, and the resource assignment component 1540 may be configured as or otherwise support a means for transmitting a fourth control signal assigning the second set of subcarriers to the first UE, the second UE, or a third UE for sidelink communication based on the second set of subcarriers being non-contiguous with the first set of subcarriers within the sub-slot, where the different transmission time intervals include the sub-slot.

In some examples, the set of multiple resource patterns corresponds to a set of multiple transport block sizes, a set of multiple transmission priorities, or both. In some examples, the first resource pattern of the set of multiple resource patterns corresponds to a first transport block size for a first sidelink signal corresponding to the first UE, a first transmission priority for the first sidelink signal corresponding to the first UE, or both. In some examples, the second resource pattern of the set of multiple resource patterns corresponds to a second transport block size for a second sidelink signal corresponding to the second UE, a second transmission priority for the second sidelink signal corresponding to the second UE, or both.

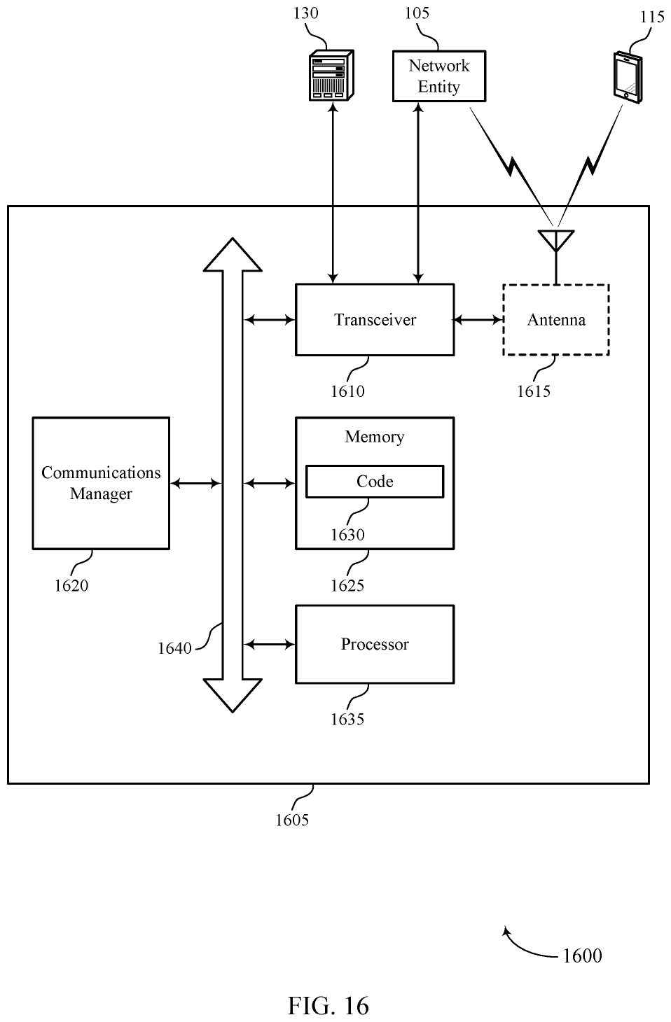

FIG. 16 shows a diagram of a system 1600 including a device 1605 that supports resource pattern configuration within a slot for sidelink communication in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. The transceiver 1610, or the transceiver 1610 and one or more antennas 1615 or wired interfaces, where applicable, may be an example of a transmitter 1315, a transmitter 1415, a receiver 1310, a receiver 1410, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting resource pattern configuration within a slot for sidelink communication). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605 and may process information received from other components (such as inputs or signals) or output information to other components. For example, a chip or modem of the device 1605 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1605 may transmit information output from the chip or modem. In some implementations, the second interface may refer to an interface between the processing system of the chip or modem and a receiver, such that the device 1605 may obtain information or signal inputs, and the information may be passed to the processing system. A person having ordinary skill in the art will readily recognize that the first interface also may obtain information or signal inputs, and the second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications at a network entity in accordance with examples as disclosed herein. For example, the communications manager 1620 may be configured as or otherwise support a means for transmitting a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The communications manager 1620 may be configured as or otherwise support a means for transmitting a second control signal assigning a first resource pattern of the set of multiple resource patterns to a first UE for sidelink communication within the slot. The communications manager 1620 may be configured as or otherwise support a means for transmitting a third control signal assigning a second resource pattern of the set of multiple resource patterns to a second UE for sidelink communication within the slot.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the processor 1635, the memory 1625, the code 1630, the transceiver 1610, or any combination thereof. For example, the code 1630 may include instructions executable by the processor 1635 to cause the device 1605 to perform various aspects of resource pattern configuration within a slot for sidelink communication as described herein, or the processor 1635 and the memory 1625 may be otherwise configured to perform or support such operations.

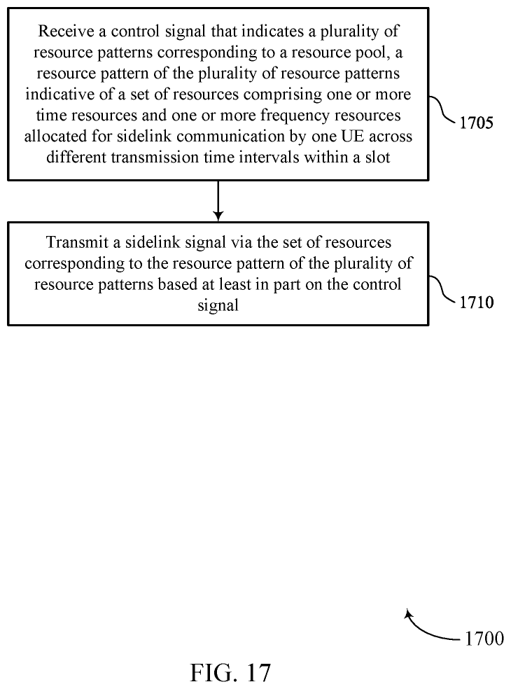

FIG. 17 shows a flowchart illustrating a method 1700 that supports resource pattern configuration within a slot for sidelink communication in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving a control signal that indicates a set of multiple resource patterns corresponding to a resource pool. A resource pattern of the set of multiple resource patterns may indicate a set of resources including one or more time resources and one or more frequency resources allocated for sidelink communication by one UE across different transmission time intervals within a slot. The operations of 1705 may be performed in accordance with examples as disclosed herein. In some examples, aspects of the operations of 1705 may be performed by a resource pattern configuration component 1125 as described with reference to FIG. 11.

At 1710, the method may include transmitting a sidelink signal via the set of resources corresponding to the resource pattern of the set of multiple resource patterns based on the control signal. The operations of 1710 may be performed in accordance with examples as disclosed herein. In some examples, aspects of the operations of 1710 may be performed by a sidelink signaling component 1130 as described with reference to FIG. 11.

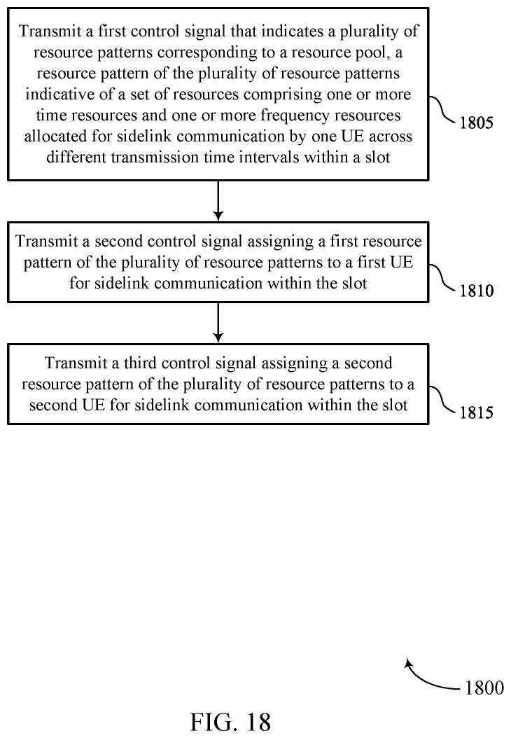

FIG. 18 shows a flowchart illustrating a method 1800 that supports resource pattern configuration within a slot for sidelink communication in accordance with one or more aspects of the present disclosure. The operations of the method 1800 may be implemented by a network entity (e.g., a base station, an RU, a DU, a CU) or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include transmitting a first control signal that indicates a set of multiple resource patterns corresponding to a resource pool, a resource pattern of the set of multiple resource patterns indicative of a set of resources including one or more time resources and one or more frequency resources allocated for sidelink communication by one UE across different transmission time intervals within a slot. The operations of 1805 may be performed in accordance with examples as disclosed herein. In some examples, aspects of the operations of 1805 may be performed by a resource pattern configuration component 1525 as described with reference to FIG. 15.

At 1810, the method may include transmitting a second control signal assigning a first resource pattern of the set of multiple resource patterns to a first UE for sidelink communication within the slot. The operations of 1810 may be performed in accordance with examples as disclosed herein. In some examples, aspects of the operations of 1810 may be performed by a resource pattern assignment component 1530 as described with reference to FIG. 15.

At 1815, the method may include transmitting a third control signal assigning a second resource pattern of the set of multiple resource patterns to a second UE for sidelink communication within the slot. The operations of 1815 may be performed in accordance with examples as disclosed herein. In some examples, aspects of the operations of 1815 may be performed by a resource pattern assignment component 1530 as described with reference to FIG. 15.

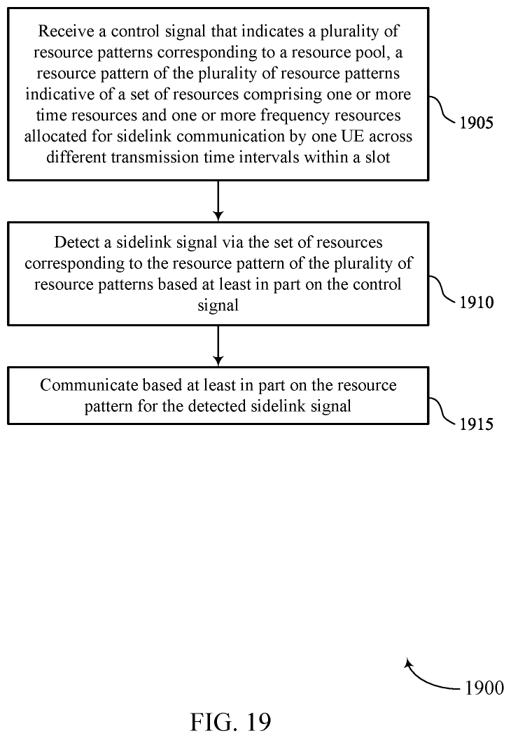

FIG. 19 shows a flowchart illustrating a method 1900 that supports resource pattern configuration within a slot for sidelink communication in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving a control signal that indicates a set of multiple resource patterns corresponding to a resource pool. A resource pattern of the set of multiple resource patterns may indicate a set of resources including one or more time resources and one or more frequency resources allocated for sidelink communication by one UE across different transmission time intervals within a slot. The operations of 1905 may be performed in accordance with examples as disclosed herein. In some examples, aspects of the operations of 1905 may be performed by a resource pattern configuration component 1125 as described with reference to FIG. 11.

At 1910, the method may include detecting a sidelink signal via the set of resources corresponding to the resource pattern of the set of multiple resource patterns based on the control signal. The operations of 1910 may be performed in accordance with examples as disclosed herein. In some examples, aspects of the operations of 1910 may be performed by a sidelink detection component 1135 as described with reference to FIG. 11.

At 1915, the method may include communicating based on the resource pattern for the detected sidelink signal. The operations of 1915 may be performed in accordance with examples as disclosed herein. In some examples, aspects of the operations of 1915 may be performed by a sidelink signaling component 1130 as described with reference to FIG. 11.

The following provides an overview of aspects of the present disclosure:

Aspect 1: A method for wireless communications at a UE, comprising: receiving a control signal that indicates a plurality of resource patterns corresponding to a resource pool, a resource pattern of the plurality of resource patterns indicative of a set of resources comprising one or more time resources and one or more frequency resources allocated for sidelink communication by one UE across different transmission time intervals within a slot; and transmitting a sidelink signal via the set of resources corresponding to the resource pattern of the plurality of resource patterns based at least in part on the control signal.

Aspect 2: The method of aspect 1, further comprising: receiving a second control signal assigning the resource pattern of the plurality of resource patterns to the UE, wherein the sidelink signal is transmitted via the set of resources corresponding to the resource pattern based at least in part on the second control signal.

Aspect 3: The method of aspect 1, further comprising: determining the resource pattern from the plurality of resource patterns based at least in part on a source identifier for the sidelink signal, a destination identifier for the sidelink signal, or both, wherein the sidelink signal is transmitted via the set of resources corresponding to the resource pattern based at least in part on the determining.

Aspect 4: The method of any of aspects 1 through 3, further comprising: transmitting a sidelink control signal indicating the resource pattern based at least in part on transmitting the sidelink signal via the set of resources corresponding to the resource pattern.

Aspect 5: The method of any of aspects 1 through 4, wherein: the plurality of resource patterns corresponds to a plurality of transport block sizes, a plurality of transmission priorities, or both; and the resource pattern of the plurality of resource patterns corresponds to a transport block size for the sidelink signal, a transmission priority for the sidelink signal, or both.

Aspect 6: The method of any of aspects 1 through 5, wherein transmitting the sidelink signal further comprises: performing frequency hopping for transmission of the sidelink signal from a first set of subcarriers during a first sub-slot of the slot to a second set of subcarriers different from the first set of subcarriers during a second sub-slot of the slot based at least in part on the resource pattern, wherein the different transmission time intervals include the first sub-slot and the second sub-slot.

Aspect 7: The method of aspect 6, wherein the first set of subcarriers is separated from the second set of subcarriers in frequency by a frequency offset.

Aspect 8: The method of any of aspects 1 through 7, wherein transmitting the sidelink signal comprises: transmitting a first portion of the sidelink signal during a first sub-slot of the slot via a first set of subcarriers associated with a first resource index based at least in part on one or more initial offset values; and transmitting a second portion of the sidelink signal during a second sub-slot of the slot via a second set of subcarriers associated with a second resource index based at least in part on the first resource index, wherein the different transmission time intervals include the first sub-slot and the second sub-slot.

Aspect 9: The method of aspect 8, further comprising: receiving a second control signal indicating a set of offset values, wherein the one or more initial offset values are based at least in part on the set of offset values.

Aspect 10: The method of aspect 9, wherein an offset value of the set of offset values is common across UEs for the resource pool or is specific to the UE for the resource pool.

Aspect 11: The method of any of aspects 8 through 10, further comprising: transmitting a sidelink control signal comprising a bit map indicating the one or more initial offset values based at least in part on transmitting the first portion of the sidelink signal via the first set of subcarriers associated with the first resource index based at least in part on the one or more initial offset values.

Aspect 12: The method of any of aspects 8 through 11, wherein the second resource index is based at least in part on the first resource index and a staircase technique for resource assignment or a bit reversal permutation technique for resource assignment.

Aspect 13: The method of any of aspects 1 through 12, wherein the resource pattern indicates, for the UE, a first set of subcarriers and a second set of subcarriers non-contiguous in frequency within a sub-slot and the transmitting the sidelink signal comprises: refraining from transmitting a portion of the sidelink signal via the second set of subcarriers based at least in part on the second set of subcarriers being non-contiguous in frequency with the first set of subcarriers; repeating a transport block transmission via the second set of subcarriers based at least in part on the second set of subcarriers being non-contiguous in frequency with the first set of subcarriers; or transmitting a first transport block via the first set of subcarriers and transmitting a second transport block via the second set of subcarriers based at least in part on the second set of subcarriers being non-contiguous in frequency with the first set of subcarriers, wherein the different transmission time intervals include the sub-slot.

Aspect 14: The method of any of aspects 1 through 13, further comprising: receiving, in response to the sidelink signal, a sidelink feedback signal via sidelink feedback channel resources, wherein the sidelink feedback channel resources are based at least in part on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof, wherein the different transmission time intervals include the first sub-slot and the last sub-slot.

Aspect 15: A method for wireless communications at a network entity, comprising: transmitting a first control signal that indicates a plurality of resource patterns corresponding to a resource pool, a resource pattern of the plurality of resource patterns indicative of a set of resources comprising one or more time resources and one or more frequency resources allocated for sidelink communication by one UE across different transmission time intervals within a slot; transmitting a second control signal assigning a first resource pattern of the plurality of resource patterns to a first UE for sidelink communication within the slot; and transmitting a third control signal assigning a second resource pattern of the plurality of resource patterns to a second UE for sidelink communication within the slot.

Aspect 16: The method of aspect 15, further comprising: transmitting a fourth control signal indicating a set of offset values for the first UE and the second UE, wherein an offset value of the set of offset values indicates an assigned set of resources for sidelink communication based at least in part on an assigned resource pattern.

Aspect 17: The method of aspect 16, wherein the set of offset values comprises a first offset value specific to the first UE for the resource pool, a second offset value specific to the second UE for the resource pool, a third offset value common to the first UE and the second UE for the resource pool, or any combination thereof.

Aspect 18: The method of aspect 15, wherein the first resource pattern indicates, for the first UE, a first set of subcarriers and a second set of subcarriers non-contiguous in frequency within a sub-slot of the slot, the method further comprising: transmitting a fourth control signal assigning the second set of subcarriers to the first UE, the second UE, or a third UE for sidelink communication based at least in part on the second set of subcarriers being non-contiguous with the first set of subcarriers within the sub-slot, wherein the different transmission time intervals include the sub-slot.

Aspect 19: The method of any of aspects 15 through 18, wherein: the plurality of resource patterns corresponds to a plurality of transport block sizes, a plurality of transmission priorities, or both; the first resource pattern of the plurality of resource patterns corresponds to a first transport block size for a first sidelink signal corresponding to the first UE, a first transmission priority for the first sidelink signal corresponding to the first UE, or both; and the second resource pattern of the plurality of resource patterns corresponds to a second transport block size for a second sidelink signal corresponding to the second UE, a second transmission priority for the second sidelink signal corresponding to the second UE, or both.

Aspect 20: A method for wireless communications at a UE, comprising: receiving a control signal that indicates a plurality of resource patterns corresponding to a resource pool, a resource pattern of the plurality of resource patterns indicative of a set of resources comprising one or more time resources and one or more frequency resources allocated for sidelink communication by one UE across different transmission time intervals within a slot; detecting a sidelink signal via the set of resources corresponding to the resource pattern of the plurality of resource patterns based at least in part on the control signal; and communicating based at least in part on the resource pattern for the detected sidelink signal.

Aspect 21: The method of aspect 20, wherein the communicating comprises: receiving the sidelink signal based at least in part on the resource pattern.

Aspect 22: The method of aspect 21, further comprising: transmitting, in response to the sidelink signal, a sidelink feedback signal via sidelink feedback channel resources, wherein the sidelink feedback channel resources are based at least in part on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof, wherein the different transmission time intervals include the first sub-slot and the last sub-slot.

Aspect 23: The method of any of aspects 20 through 22, wherein the communicating comprises: transmitting a second sidelink signal via a second set of resources corresponding to a second resource pattern of the plurality of resource patterns based at least in part on the resource pattern for the detected sidelink signal.

Aspect 24: The method of any of aspects 20 through 23, wherein detecting the sidelink signal comprises: receiving a sidelink control signal associated with the sidelink signal and indicating the resource pattern for the sidelink signal.

Aspect 25: The method of any of aspects 20 through 24, further comprising: determining the resource pattern for the sidelink signal based at least in part on a source identifier for the sidelink signal, a destination identifier for the sidelink signal, or both.

Aspect 26: The method of any of aspects 20 through 25, wherein detecting the sidelink signal comprises: receiving a sidelink control signal associated with the sidelink signal and comprising a bit map indicating one or more initial offset values for the sidelink signal; and determining the set of resources corresponding to the resource pattern for the sidelink signal based at least in part on the bit map.

Aspect 27: An apparatus for wireless communications at a UE, comprising a processor; memory coupled with the processor; and instructions stored in the memory and executable by the processor to cause the apparatus to perform a method of any of aspects 1 through 14.

Aspect 28: An apparatus for wireless communications at a UE, comprising at least one means for performing a method of any of aspects 1 through 14.

Aspect 29: A non-transitory computer-readable medium storing code for wireless communications at a UE, the code comprising instructions executable by a processor to perform a method of any of aspects 1 through 14.

Aspect 30: An apparatus for wireless communications at a network entity, comprising a processor; memory coupled with the processor; and instructions stored in the memory and executable by the processor to cause the apparatus to perform a method of any of aspects 15 through 19.

Aspect 31: An apparatus for wireless communications at a network entity, comprising at least one means for performing a method of any of aspects 15 through 19.

Aspect 32: A non-transitory computer-readable medium storing code for wireless communications at a network entity, the code comprising instructions executable by a processor to perform a method of any of aspects 15 through 19.

Aspect 33: An apparatus for wireless communications at a UE, comprising a processor; memory coupled with the processor; and instructions stored in the memory and executable by the processor to cause the apparatus to perform a method of any of aspects 20 through 26.

Aspect 34: An apparatus for wireless communications at a UE, comprising at least one means for performing a method of any of aspects 20 through 26.

Aspect 35: A non-transitory computer-readable medium storing code for wireless communications at a UE, the code comprising instructions executable by a processor to perform a method of any of aspects 20 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a control signal that indicates a plurality of resource patterns corresponding to a resource pool, a resource pattern of the plurality of resource patterns indicative of a set of resources comprising one or more time resources and one or more frequency resources allocated for sidelink communication by one UE across different transmission time intervals within a slot; and
transmit a sidelink signal via the set of resources corresponding to the resource pattern of the plurality of resource patterns based at least in part on the control signal.

2. The apparatus of claim 1, wherein the instructions are further executable by the processor to cause the apparatus to:
receive a second control signal assigning the resource pattern of the plurality of resource patterns to the UE, wherein the sidelink signal is transmitted via the set of resources corresponding to the resource pattern based at least in part on the second control signal.

3. The apparatus of claim 1, wherein the instructions are further executable by the processor to cause the apparatus to:
determine the resource pattern from the plurality of resource patterns based at least in part on a source identifier for the sidelink signal, a destination identifier for the sidelink signal, or both, wherein the sidelink signal is transmitted via the set of resources corresponding to the resource pattern based at least in part on the determining.

4. The apparatus of claim 1, wherein the instructions are further executable by the processor to cause the apparatus to:
transmit a sidelink control signal indicating the resource pattern based at least in part on transmitting the sidelink signal via the set of resources corresponding to the resource pattern.

5. The apparatus of claim 1, wherein:
the plurality of resource patterns corresponds to a plurality of transport block sizes, a plurality of transmission priorities, or both; and
the resource pattern of the plurality of resource patterns corresponds to a transport block size for the sidelink signal, a transmission priority for the sidelink signal, or both.

6. The apparatus of claim 1, wherein the instructions to transmit the sidelink signal are further executable by the processor to cause the apparatus to:
perform frequency hopping for transmission of the sidelink signal from a first set of subcarriers during a first sub-slot of the slot to a second set of subcarriers different from the first set of subcarriers during a second sub-slot of the slot based at least in part on the resource pattern, wherein the different transmission time intervals include the first sub-slot and the second sub-slot.

7. The apparatus of claim 6, wherein the first set of subcarriers is separated from the second set of subcarriers in frequency by a frequency offset.

8. The apparatus of claim 1, wherein the instructions to transmit the sidelink signal are executable by the processor to cause the apparatus to:
transmit a first portion of the sidelink signal during a first sub-slot of the slot via a first set of subcarriers associated with a first resource index based at least in part on one or more initial offset values; and
transmit a second portion of the sidelink signal during a second sub-slot of the slot via a second set of subcarriers associated with a second resource index based at least in part on the first resource index, wherein the different transmission time intervals include the first sub-slot and the second sub-slot.

9. The apparatus of claim 8, wherein the instructions are further executable by the processor to cause the apparatus to:
receive a second control signal indicating a set of offset values, wherein the one or more initial offset values are based at least in part on the set of offset values.

10. The apparatus of claim 9, wherein an offset value of the set of offset values is common across UEs for the resource pool or is specific to the UE for the resource pool.

11. The apparatus of claim 8, wherein the instructions are further executable by the processor to cause the apparatus to:
transmit a sidelink control signal comprising a bit map indicating the one or more initial offset values based at least in part on transmitting the first portion of the sidelink signal via the first set of subcarriers associated with the first resource index based at least in part on the one or more initial offset values.

12. The apparatus of claim 8, wherein the second resource index is based at least in part on the first resource index and a staircase technique for resource assignment or a bit reversal permutation technique for resource assignment.

13. The apparatus of claim 1, wherein the resource pattern indicates, for the UE, a first set of subcarriers and a second set of subcarriers non-contiguous in frequency within a sub-slot and the instructions to transmit the sidelink signal are executable by the processor to cause the apparatus to:
refrain from transmitting a portion of the sidelink signal via the second set of subcarriers based at least in part on the second set of subcarriers being non-contiguous in frequency with the first set of subcarriers;
repeat a transport block transmission via the second set of subcarriers based at least in part on the second set of subcarriers being non-contiguous in frequency with the first set of subcarriers; or
transmit a first transport block via the first set of subcarriers and transmitting a second transport block via the second set of subcarriers based at least in part on the second set of subcarriers being non-contiguous in frequency with the first set of subcarriers, wherein the different transmission time intervals include the sub-slot.

14. The apparatus of claim 1, wherein the instructions are further executable by the processor to cause the apparatus to:
receive, in response to the sidelink signal, a sidelink feedback signal via sidelink feedback channel resources, wherein the sidelink feedback channel resources are based at least in part on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof, wherein the different transmission time intervals include the first sub-slot and the last sub-slot.

15. An apparatus for wireless communications at a network entity, comprising:
a processor;
memory coupled with the processor; and
instructions stored in the memory and executable by the processor to cause the apparatus to:
transmit a first control signal that indicates a plurality of resource patterns corresponding to a resource pool, a resource pattern of the plurality of resource patterns indicative of a set of resources comprising one or more time resources and one or more frequency resources allocated for sidelink communication by one user equipment (UE) across different transmission time intervals within a slot;
transmit a second control signal assigning a first resource pattern of the plurality of resource patterns to a first UE for sidelink communication within the slot; and
transmit a third control signal assigning a second resource pattern of the plurality of resource patterns to a second UE for sidelink communication within the slot.

16. The apparatus of claim 15, wherein the instructions are further executable by the processor to cause the apparatus to:
transmit a fourth control signal indicating a set of offset values for the first UE and the second UE, wherein an offset value of the set of offset values indicates an assigned set of resources for sidelink communication based at least in part on an assigned resource pattern.

17. The apparatus of claim 16, wherein the set of offset values comprises a first offset value specific to the first UE for the resource pool, a second offset value specific to the second UE for the resource pool, a third offset value common to the first UE and the second UE for the resource pool, or any combination thereof.

18. The apparatus of claim 15, wherein the first resource pattern indicates, for the first UE, a first set of subcarriers and a second set of subcarriers non-contiguous in frequency within a sub-slot of the slot, and the instructions are further executable by the processor to cause the apparatus to:
transmit a fourth control signal assigning the second set of subcarriers to the first UE, the second UE, or a third UE for sidelink communication based at least in part on the second set of subcarriers being non-contiguous with the first set of subcarriers within the sub-slot, wherein the different transmission time intervals include the sub-slot.

19. The apparatus of claim 15, wherein:
the plurality of resource patterns corresponds to a plurality of transport block sizes, a plurality of transmission priorities, or both;
the first resource pattern of the plurality of resource patterns corresponds to a first transport block size for a first sidelink signal corresponding to the first UE, a first transmission priority for the first sidelink signal corresponding to the first UE, or both; and
the second resource pattern of the plurality of resource patterns corresponds to a second transport block size for a second sidelink signal corresponding to the second UE, a second transmission priority for the second sidelink signal corresponding to the second UE, or both.

20. An apparatus for wireless communications at a user equipment (UE), comprising:
a processor;
memory coupled with the processor; and
instructions stored in the memory and executable by the processor to cause the apparatus to:
receive a control signal that indicates a plurality of resource patterns corresponding to a resource pool, a resource pattern of the plurality of resource patterns indicative of a set of resources comprising one or more time resources and one or more frequency resources allocated for sidelink communication by one UE across different transmission time intervals within a slot;
detect a sidelink signal via the set of resources corresponding to the resource pattern of the plurality of resource patterns based at least in part on the control signal; and
communicate based at least in part on the resource pattern for the detected sidelink signal.

21. The apparatus of claim 20, wherein the instructions to communicate are executable by the processor to cause the apparatus to:
receive the sidelink signal based at least in part on the resource pattern.

22. The apparatus of claim 21, wherein the instructions are further executable by the processor to cause the apparatus to:
transmit, in response to the sidelink signal, a sidelink feedback signal via sidelink feedback channel resources, wherein the sidelink feedback channel resources are based at least in part on a start subchannel index and a sub-slot index for a first sub-slot of the sidelink signal, the start subchannel index and the sub-slot index for a last sub-slot of the sidelink signal, a quantity of subchannels and the sub-slot index for the first sub-slot of the sidelink signal, the quantity of subchannels and the sub-slot index for the last sub-slot of the sidelink signal, or any combination thereof, wherein the different transmission time intervals include the first sub-slot and the last sub-slot.

23. The apparatus of claim 20, wherein the instructions to communicate are executable by the processor to cause the apparatus to:
transmit a second sidelink signal via a second set of resources corresponding to a second resource pattern of the plurality of resource patterns based at least in part on the resource pattern for the detected sidelink signal.

24. The apparatus of claim 20, wherein the instructions to detect the sidelink signal are executable by the processor to cause the apparatus to:
receive a sidelink control signal associated with the sidelink signal and indicating the resource pattern for the sidelink signal.

25. The apparatus of claim 20, wherein the instructions are further executable by the processor to cause the apparatus to:
determine the resource pattern for the sidelink signal based at least in part on a source identifier for the sidelink signal, a destination identifier for the sidelink signal, or both.

26. The apparatus of claim 20, wherein the instructions to detect the sidelink signal are executable by the processor to cause the apparatus to:
receive a sidelink control signal associated with the sidelink signal and comprising a bit map indicating one or more initial offset values for the sidelink signal; and
determine the set of resources corresponding to the resource pattern for the sidelink signal based at least in part on the bit map.

27. A method for wireless communications at a user equipment (UE), comprising:
receiving a control signal that indicates a plurality of resource patterns corresponding to a resource pool, a resource pattern of the plurality of resource patterns indicative of a set of resources comprising one or more time resources and one or more frequency resources allocated for sidelink communication by one UE across different transmission time intervals within a slot; and
transmitting a sidelink signal via the set of resources corresponding to the resource pattern of the plurality of resource patterns based at least in part on the control signal.

28. The method of claim 27, further comprising:
receiving a second control signal assigning the resource pattern of the plurality of resource patterns to the UE, wherein the sidelink signal is transmitted via the set of resources corresponding to the resource pattern based at least in part on the second control signal.

29. The method of claim 27, further comprising:
determining the resource pattern from the plurality of resource patterns based at least in part on a source identifier for the sidelink signal, a destination identifier for the sidelink signal, or both, wherein the sidelink signal is transmitted via the set of resources corresponding to the resource pattern based at least in part on the determining.

30. The method of claim 27, further comprising:
transmitting a sidelink control signal indicating the resource pattern based at least in part on transmitting the sidelink signal via the set of resources corresponding to the resource pattern.
